(19) United States
(12) Patent Application Publication
(10) Pub. No.: US 2025/0291871 A1
(43) Pub. Date: Sep. 18, 2025

(54) CONSTRAINED SOLUTION WITH PREFERENCES TO SOLVE COMBINATORIAL PROBLEMS IN NEURAL NETWORKS

(71) Applicant: EMBIE CLINIC LTD, Ramat Gan (IL)

(72) Inventors: Shirli DI-CASTRO SHASHUA, Kfar Saba (IL); Doris Dana AVERBUCH, Kfar Saba (IL); Ido YOHANAN, Kibbutz Gvat (IL); Gabriel MASHBAUM HEILMAN, Modiin (IL)

(73) Assignee: EMBIE CLINIC LTD, Ramat Gan (IL)

(21) Appl. No.: 18/965,917

(22) Filed: Dec. 2, 2024

Related U.S. Application Data
(60) Provisional application No. 63/565,333, filed on Mar. 14, 2024.

(51) Int. Cl. G06F 17/11

(52) U.S. Cl. CPC G06F 17/11

(57) ABSTRACT

A system may access a task associated with a context, an action set, one or more constraints, and one or more preferences, wherein a multi-objective outcome is to be generated for the task based on the action set, the one or more constraints and the one or more preferences. A system may execute a neural network having an encoder-decoder architecture comprising an encoder and a decoder to satisfy the task and achieve the multi-objective outcome, wherein the neural network applies one or more preferences in a mask-like function that to take into account the one or more preferences. A system may generate, based on the action set, a solution having the multi-objective outcome selected from the action set, the solution complying with the one or more constraints and taking into account the one or more preferences.

### RELATED APPLICATIONS

This application claims priority to U.S. Provisional Patent Application No. 63/565,333, filed on Mar. 14, 2024, entitled, “Platforms, Systems and Methods for Fertility Treatment Support,” the entire content of which is incorporated by reference in its entirety herein.

### BACKGROUND

Neural networks may be used in a wide variety of computational tasks, including multi-objective optimizations in which a neural network is trained to find a solution that optimizes multiple objectives simultaneously.

### BRIEF DESCRIPTION OF THE DRAWINGS

Features of the present disclosure may be illustrated by way of example and not limited in the following Figure(s), in which like numerals indicate like elements.

FIG. 1 illustrates an example of a system environment for multi-objective optimization for task resolution based on an action set, constraints, context and preferences using a neural network having an encoder-decoder architecture.

FIG. 2 illustrates a flow diagram of an example of multi-objective optimization for task resolution in the computer system 110 illustrated in FIG. 1.

FIG. 3 illustrates an example of an encoder layers architecture that processes context vectors.

FIG. 4 illustrates an example of an encoder layers architecture that processes an action set.

FIG. 5 illustrates an example of components for processing by the decoder on an action set from the encoder.

FIG. 6 illustrates an example of generating score vectors by the decoder based on an action set from the encoder.

FIG. 7 illustrates an example of applying constraints and preferences into the score vector and creating the masked-score vector

FIG. 8 illustrates an example of calculating the conditional probability vector from the masked-score vector and sampling a chosen action element from an action set.

FIG. 9 illustrates an example of generating a score vector for a first action set.

FIG. 10 illustrates an example of integrating constraints and preferences into the score vector for the first action set.

FIG. 11 illustrates an example of calculating the conditional probability vector from the masked-score vector over the first action set and sampling a chosen action element from the first action set.

FIG. 12 illustrates an example of generating a score vector for a second action set.

FIG. 13 illustrates an example of integrating constraints and preferences into the score vector for the second action set.

FIG. 14 illustrates an example of calculating the conditional probability vector from the masked-score vector over the second action set and sampling a chosen action element from the second action set.

FIG. 15 illustrates an example of three different tasks of scheduling appointments in clinics. Each task includes a context of patient and appointment, constraints, preferences and it may include action sets of doctors, nurses, embryologists, clinic facilities and time slots.

FIG. 16 illustrates an example of a flow diagram of multi-objective optimization for task resolution in the computer system illustrated in FIG. 1, specifically for the task of scheduling appointments in clinics.

FIG. 17 illustrates an example of an encoder layers architecture that embeds and processes patient and appointment feature vectors in a clinic appointment scheduling task

FIG. 18 illustrates an example of an encoder layers architecture that embeds and processes an action set of care providers feature vectors in a clinic appointment scheduling task

FIG. 19 illustrates an example of generating score vectors by the decoder based on the care provider action set hidden vectors from the encoder.

FIG. 20 illustrates an example of applying constraints and preferences into the score vector for the care provider action set and creating the masked-score vector.

FIG. 21 illustrates an example of calculating the conditional probability vector from the masked-score vector over care providers action set and sampling a chosen care provider from its action set.

FIG. 22 illustrates an example of generating score vectors by the decoder based on the clinic facility action set hidden vectors from the encoder and the chosen care provider.

FIG. 23 illustrates an example of applying constraints and preferences into the score vector for the clinic facilities action set and creating the masked-score vector.

FIG. 24 illustrates an example of calculating the conditional probability vector from the masked-score vector over clinic facilities action set and sampling a chosen clinic facility from its action set.

FIG. 25 illustrates an example of generating score vectors by the decoder based on the time slots action set hidden vectors from the encoder and the chosen care provider and clinic facility.

FIG. 26 illustrates an example of applying constraints and preferences into the score vector for the time slots action set and creating the masked-score vector.

FIG. 27 illustrates an example of calculating the conditional probability vector from the masked-score vector over time slots action set and sampling a time slot from its action set.

FIG. 28 illustrates a method of generating a solution having multi-objective optimization based on an action set, constraints, context and preferences using a neural network having an encoder-decoder architecture.

FIG. 29 illustrates a method of generating a solution having multi-objective optimization using a neural network having an encoder-decoder architecture.

FIG. 30 illustrates an example of a computing system implemented by one or more of the devices illustrated in FIG. 1.

### DETAILED DESCRIPTION

The disclosure relates to multi-objective optimization for task resolution based on an action set, constraints, context and preferences using a neural network having an encoder-decoder architecture. The computer system 110 enables use of constraints in combinatorial problems, while taking into account preferences in combinatorial problems that influence solutions but do not remove options from consideration. To do so, the computer system 110 may implement the preferences based on “mask-like” calculated scores according to factors that are positive and smaller than one or greater than one. Optimization is performed based on a Reinforcement Learning (RL) mechanism. This enables the computer system 110 to learn optimal solutions by accounting for both past and future tasks in a queue. The computer system 110 enables solutions to complex combinatorial problems using RL and unique encoder-decoder model architecture that provides flexibility to each component. For example, the computer system 110 supports dynamically changing action space sizes and content by flexibly generating embedding vectors based on current sets of action spaces and context. For each task, the computer system 110 is able to add/remove action sets and actions sets items. This means that the computer system 110 does not require action sets or content of action set items to be predefined. Having described various improvements to neural networks for combinatorial problems, attention will now turn to a system environment that facilitates the foregoing and other improvements.

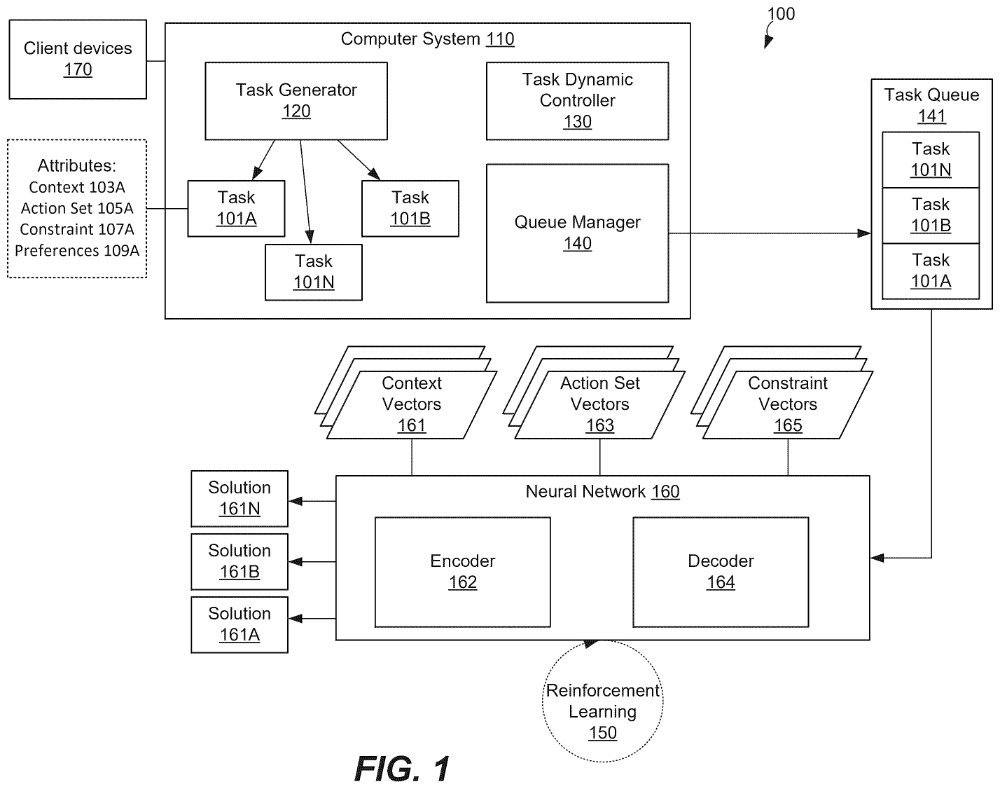

FIG. 1 illustrates an example of a system environment 100 for multi-objective optimization for task resolution based on an action set, constraints, context and preferences using a neural network having an encoder-decoder architecture.

The computer system 110 environment 100 may include a computer system 110, one or more client devices 170, and/or other components. The various components of the computer system 110 environment 100 may be connected to one another via one or more networks. One or more of the networks may be a communications network including one or more Internet Service Providers (ISPs). Each ISP may be operable to provide Internet services, telephonic services, and the like, to one or more devices, such as the computer system 110 and the client device 170, which may be used to access data from and provide data to the computer system 110. In some examples, one or more of the networks may facilitate communications via one or more communication protocols, such as those mentioned above (for example, TCP/IP, HTTP, WebRTC, SIP, WAP, Wi-Fi (for example, 802.11 protocol), Bluetooth, radio frequency systems (for example, 900 MHz, 1.4 GHz, and 5.6 GHz communication systems), cellular networks (for example, GSM, AMPS, GPRS, CDMA, EV-DO, EDGE, 3GSM, DECT, IS 136/TDMA, iDen, LTE or any other suitable cellular network protocol), infrared, BitTorrent, FTP, RTP, RTSP, SSH, and/or VOIP.

The computer system 110 may computationally solve complex combinatorial optimization problems using a dynamic reinforcement learning (RL) framework and a unique model architecture. The dynamic RL framework and model architecture integrates a combination of capabilities that produces an advanced, flexible and dynamic system that solves complex combinatorial optimization problems efficiently, while incorporating constraints and preferences. The dynamic RL framework and model architecture is scalable, context-aware, and real-time adaptable.

### Dynamic Model Architecture for Variable Action Sets

The computer system 110 may handle a variable number of action sets and elements dynamically. Unlike traditional models that require predefined, static action sets, the architecture disclosed herein supports tasks with varying action structures at each time step. This flexibility is achieved through the encoder-decoder model structure where the encoder processes each element in relation to others within its action set, allowing it to adaptively “understand” the combinatorial nature of the problem in real-time. In the decoder, conditional probability vectors are generated according to the specific number of elements present at time, which means the number of vectors can vary dynamically, and also the size of these vectors. This approach enables the computer system 110 to manage a broad range of combinatorial complexities without being limited by rigid action set structures.

### Temporal Context Integration

The disclosed optimization process accounts for contextual information across multiple time steps, including past and future events. This is achieved by the encoder that produces hidden context vectors, where each vector “knows” about others in its temporal sequence. By embedding this temporal awareness, the computer system 110 can optimize decisions by understanding not only the immediate context but also patterns from surrounding time points, leading to more informed and adaptable actions.

Decomposition of Action Policy into Conditional Probabilities

In some examples, the architecture may break down the policy action probability into a series of conditional probabilities. At each time step, the computer system 110 may first sample a primary sub-action and then progressively sample subsequent sub-actions based on the preceding choices. This decomposition is specifically adequate to combinatorial problems which include several combinatorial sets. This approach allows the computer system 110 to bypass the need to predefine and store all potential combinations of preferences and constraints for every action element, reducing both processing time and memory usage. Furthermore, this conditional approach allows the computer system 110 to represent only the relevant combinations of action elements, reducing the computations of elements that were not sampled. It also supports parallel processing of tasks and action sets across different time steps, enabling the computer system 110 to utilize GPU parallelism effectively.

### Real-Time Output of Sub-Actions and Conditional Probabilities

The disclosed model architecture in relation to policies enables both selecting sub-actions at each time step and producing the conditional probabilities vectors. This real-time capability allows for more complex problem-solving, as the computer system 110 outputs both the chosen actions and the probabilities that can inform subsequent decision-making or optimization layers.

### Implicitly Integrated Constraints and Preferences

An advantage of the computer system 110 is the implicit integration of constraints and preferences directly within the model architecture. Rather than explicitly storing or representing this information, we incorporate it through model design, reducing the size of the state representation while retaining essential decision-making data. This compact representation allows the computer system 110 to solve complex combinatorial problems efficiently by treating constraints and preferences as inherent to the model, rather than as additional components to be handled separately.

The computer system 110 may include a server device, a laptop or desktop computer, a tablet computer, a smartphone, and/or other type of computing device. The computer system 110 may be implemented as a cloud-based system and/or an on-premises system. The computer system 110 may include a task generator 120, a task dynamic controller 130, a queue manager 140, a neural network 160 having an encoder-decoder architecture, and/or other features. Some or all of these systems and/or features may be implemented in hardware or software that programs hardware.

The task generator 120 is a system that generates tasks based on logic and/or communication with the environment. For example, the task generator 120 may receive inputs from one or more client devices to generate a plurality of tasks 101 (illustrated as task 101A-N).

Each task 101 may include or be associated with a plurality of attributes. The attributes may include a context 103, one or more action sets 105, one or more constraints 107, and one or more preferences 109.

The task dynamic controller 130 is a system that dynamically updates tasks based on logic and/or communication with the environment. For example, attributes of a task 101 may change over time. In this example, the task dynamic controller 130 may dynamically update the attributes to maintain updated attributes and/or other information about a task 101. Constraints 107 may be implemented in the architecture of the model, hence, also the model structure is part of the dependencies in a probability distribution. The action set 105 defines a plurality of different actions that are optimized to satisfy the task. Each action has a corresponding option to select. Thus, multi-optimization involves selecting, for each action, the best option for that action.

A constraint 107 specifies an action that cannot be taken. A preference 109 specifies a preferred action or state. Unlike a constraint 107, a preference 109 may not absolutely prevent an action or state from being selected as part of a solution 161.

The queue manager 140 controls which tasks 101 remain in the queue, which tasks 101 are removed, and the ordering of tasks 101 in the queue. A change in a context 103 of a task may, but not necessarily, result in a removal of the task from the queue. A change in the constraints 107 may result in a change of the order of the task inside the queue. In each time step this order can be changed. The queue manager 140 may not control which tasks enter the queue, in which rate they enter, nor the rate of tasks that are pulled out from the queue for processing. Tasks 101 can enter the queue any time. At each time step, there is a certain state of the queue that indicates the content and the order of the states in it. There may be a separate “time counter” for the rate at which tasks are entering the queue and for the rate at which tasks are pulled out of the queue. This time counter may be predefined and/or configured according to particular needs. Furthermore, the time counter may be dynamically set based on the current number of tasks in the computer system 110.

### Reinforcement Learning

Reinforcement Learning (RL) 150 is a type of machine learning in which interactions with an environment enables a model to learn from the environment. RL 150 may be facilitated by an RL agent (not illustrated) that receives rewards or penalties based on its actions, and the goal is to maximize cumulative reward over time. RL 150 may be implemented based on the following state and reward description.

The state sₜ at time t includes the following information:
The tasks in the queue/bucket (both already processed and those not processed).
The current task to be processed.

Each task contains the following information:
1. The context of the task
2. The action sets related to the task
3. The elements of each action set
4. The constraints and preferences related to the context and the actions sets elements

Let be the action at time. The action contains the following sub-actions:
where is one sub-action from possible sub-actions. Notice that is the number of action sets that depends on the time.

Let be the reward at time. The reward is defined:
where is a reward function.

Let be a policy, defined as the probability of selecting action a while in state s. This probability can be written as a product of conditional probabilities:

(1)

The total expected future reward objective function may be defined as in Equation (2):

(2)

In which:
: Represents the expected cumulative reward under policy T.
: Denotes the expectation operator.
: Is the initial state.
: Is the distribution of initial states.
: Is the action taken at time t.
: Is the policy function, which gives the probability of taking action in state.
: Is the reward received at time for taking action in state.
: Represents the summation from t′=t to T.

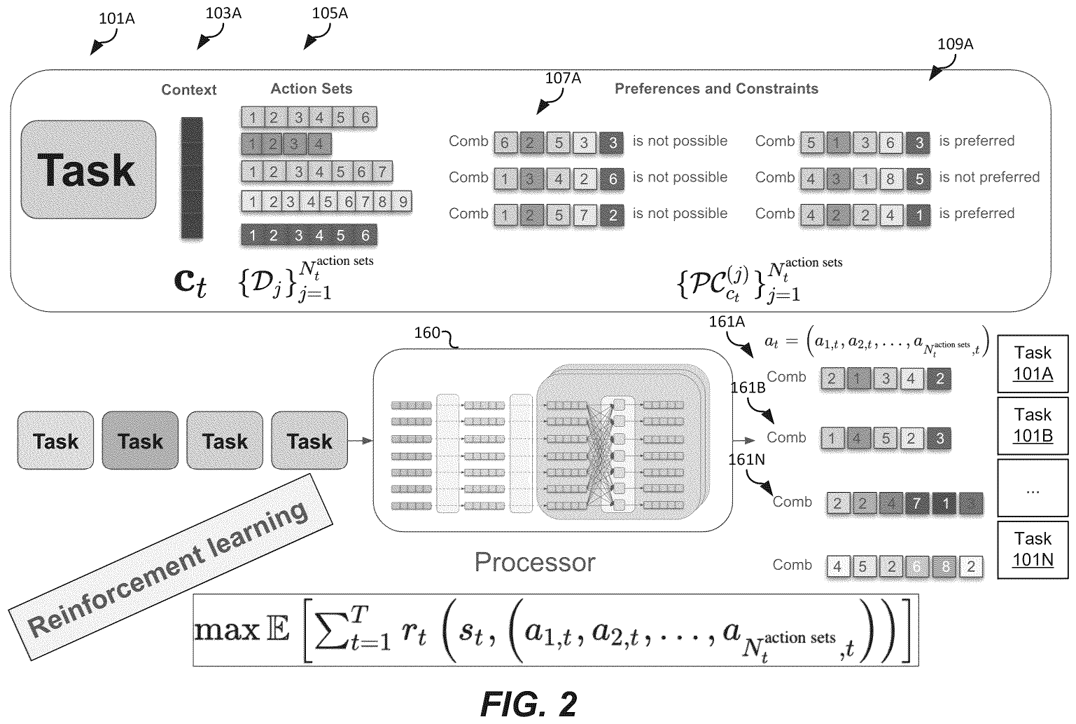

FIG. 2 illustrates an example of multi-objective optimization for task resolution in the computer system 110 illustrated in FIG. 1. In this example, the combinatorial problem is in selecting a solution from various and finite combinations of action sets, given constraints imposed on possible solutions.

The task queue 141 orders the tasks 101A-N for processing. For example, task 101A will be processed to generate a solution 161A, then the next task 101B will be processed to generate a solution 161B, and so forth until the last task 101N in the queue is processed to generate solution 161N. The specific number of tasks 101 processed will vary.

Each task 101 has its own respective attributes (context 103, action sets 105, constraints 107 and preferences 109) that are used by the neural network 160 to generate respective solutions 161. For example, as illustrated, a task 101A includes attributes: context 103A, action sets 105A, constraints 107A and preferences 109A. Some or all attributes for the task 101A may change over time. Furthermore, different tasks will have different attributes.

The context 103A may include contextual information at various time steps.

The action set 105A defines multiple actions from which to select as part of the combinatorial problem. As illustrated, there are five distinct actions in the action set 105A. Each action in the action set 105A has an option that is selected for inclusion in the solution, which can include a single solution or a distribution of more than one solution.

The constraints 107A that constrains the solution 161A. For example, the constraints 107A includes combinations of action sets that are not possible. As illustrated, there are three constraints that cannot appear in the solution 161A for task 101A. In the first constraint, the combination of action element option 6, action element option 2, action element option 5, action element option 3, and action element option 3 cannot appear in the solution 161A. In the second constraint, the combination of action element option 1, action element option 3, action element option 4, action element option 2, and action element 6 cannot appear in the solution 161A. In the third constraint, the combination of action element 1, action element 2, action element option 5, action element option 7, and action element option 2 cannot appear in the solution 161A.

The preferences 109A include preferences that should be taken into account for the solution 161A but, unlike a constraint 107A, does not necessarily eliminate an action set element from being part of the solution 161A.

At least some of the attributes will be vectorized for processing by the neural network 160. For example, the context 103 may be vectorized into context vectors and the action sets 105 may be vectorized into action set vectors.

The task 101, context 103, action set 105, constraints 107, preferences 109, and/or other inputs may be processed by the neural network 160 to determine a respective solution 161A (other tasks 101B-N will have respective solutions 161B-N).

### Neural Network Architecture

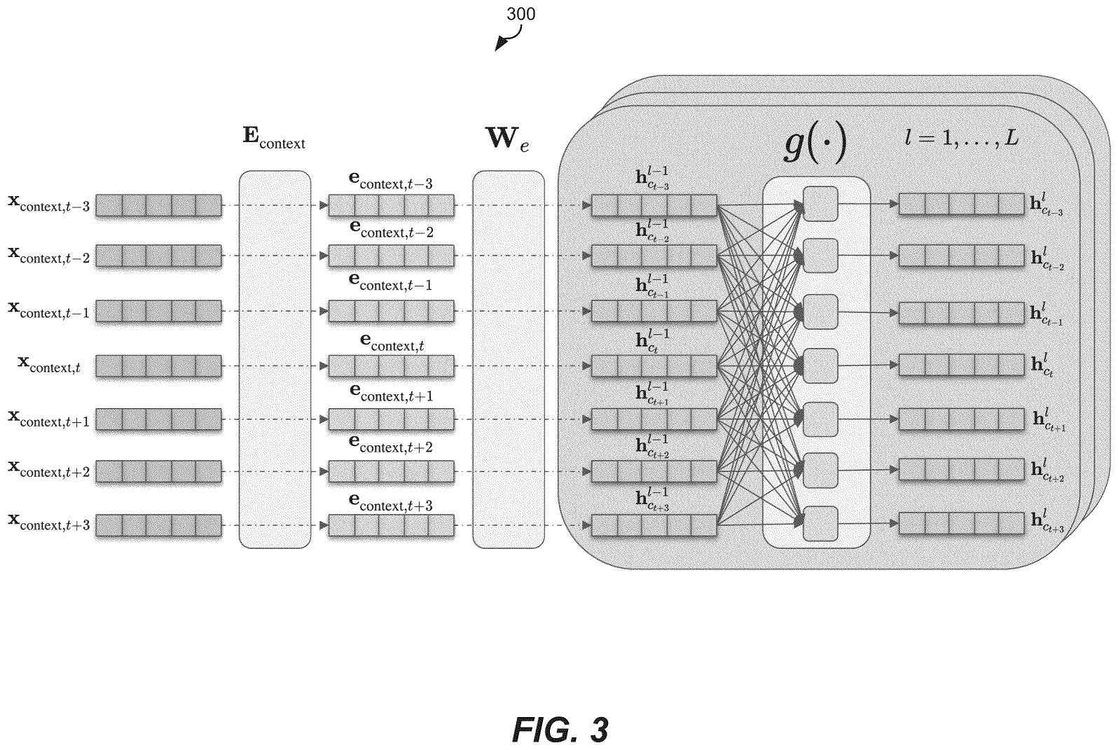

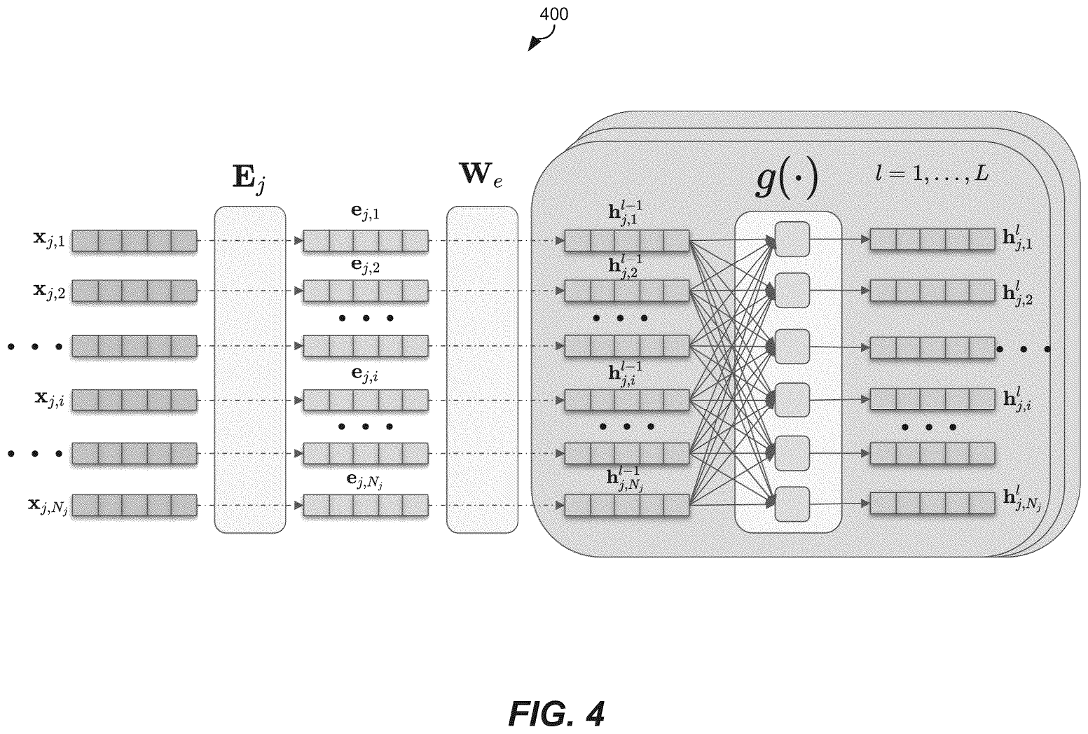

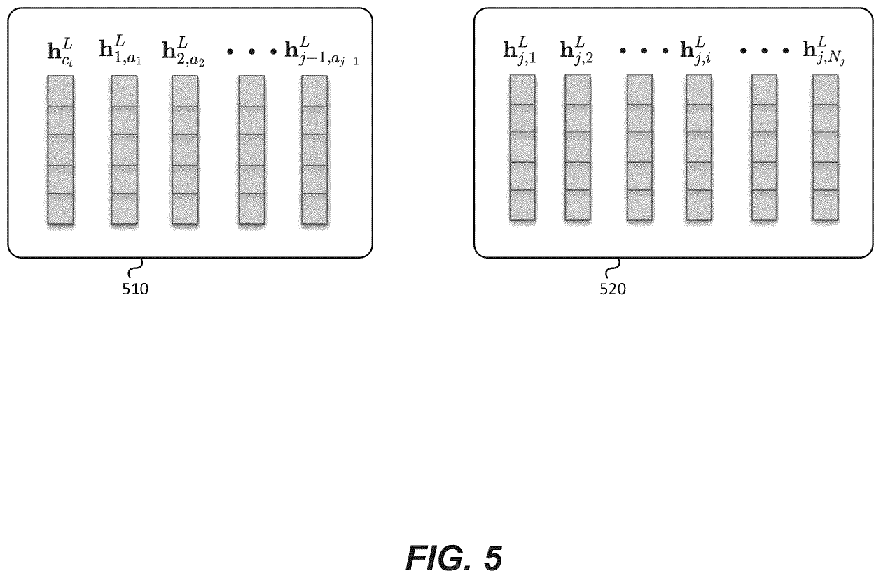

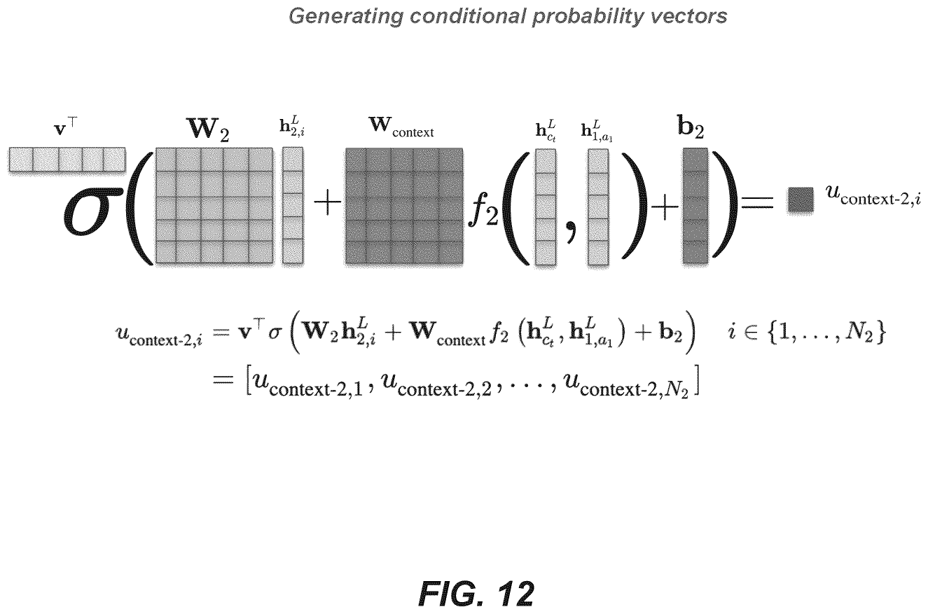

The neural network 160 may have an encoder-decoder model that includes an encoder and a decoder. As respectively illustrated in FIGS. 3 and 4, the encoder 162 may process a context set (such as context 103) and an action set (such as action set 105). FIGS. 5-8 and 9-14 illustrate examples of the decoder 164 processing an action set in view of the context set.

### Encoder-Context Processing

FIG. 3 illustrates an example of an encoder layers architecture 300 that processes a context set. Let be the feature vector of the context at time. Let be the context embedding matrix. Then, the embedding context vector is:

We denote.

Let be a matrix that converts embedding context vectors into hidden context vectors and let be the hidden vector of the context:

The computer system 110 may use an aggregation function to combine information between different contexts of different tasks in different times before and after the current context. The aggregation function may use, for example, a Graph Neural Network (GNN) architecture or Transformer architecture. Thus, each context vector 161 will hold information of all other contexts/tasks in the queue/bucket. This will be processed along the layers in the network l=1, . . . , L.

Here, represents a time index that spans a window of length, which includes the time index within it.

The aggregation function may output new hidden vectors for each context, where these vectors hold information about the other contexts in a time window T. The computer system 110 may use the hidden vector from the last layer, in the decoder, to provide the probability distributions over action sets in the decoder.

### Encoder—Action Set Processing

FIG. 4 illustrates an example of an encoder layers architecture 400 that processes an action set. Let be all the actions sets associated with the context at time:
where are the action set feature vectors of action set, is the feature dimension of elements in action set, is the total number of elements in action set and is the total number of actions sets associated with the context at time.

Let be the embedding matrices for each action set. Then, the respective embedding action set vectors are:

Let be the hidden vectors elements in action set:

The computer system 110 may use a Graph Neural Network (GNN) architecture/Transformer architecture as a function g(·) to combine information between different action elements in each action set and themselves and also between layers in the network l=1, . . . , L.

### Decoder Architecture and Processing

In the decoder 164, information between the context and the elements of each set may be combined. The objective is to identify, given the context, an element from each action set that together will form the chosen action.

This phase represents the implementation of the policy probability, as outlined in Equation (1). The operations of this phase may include:
For each action set, generate a score vector that is based on the context and the selected elements from previous action sets up to.
Integrate information related to constraints and preferences relevant to the context, elements in the current action set, and the previously selected elements.
Calculate the conditional probability vector from the masked-score vector and sample from it to select an element from the action set.

FIG. 5 illustrates an example of components (510 and 520) for processing by the decoder 164 on action set (j) from the encoder. Components 510 represent context hidden vector (last layer)+the chosen action hidden vector from previous action sets. Components 520 represent action set j elements hidden vectors (last layer).

### Generating a Conditional Probability Vector:

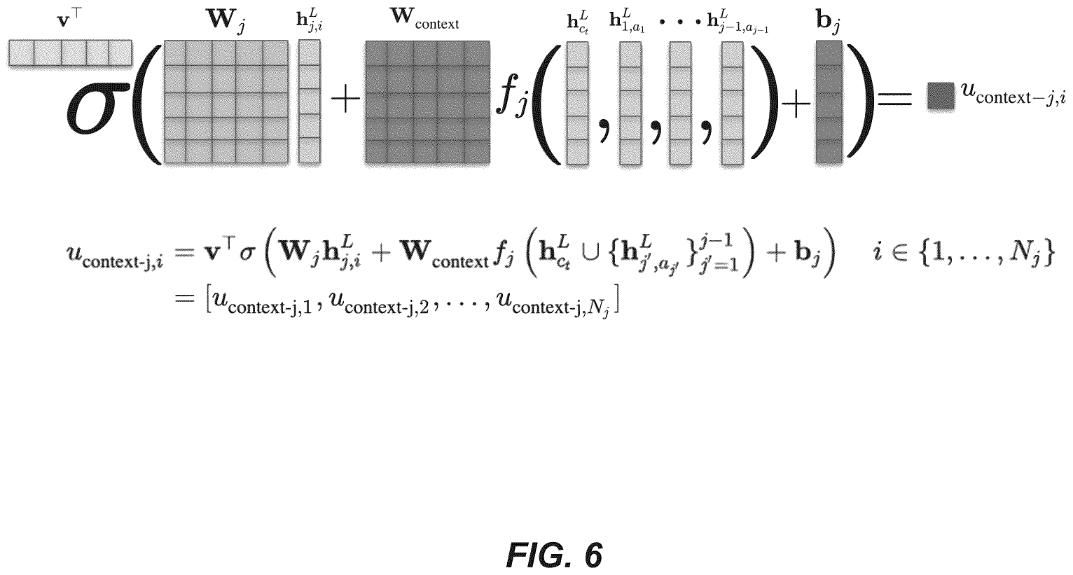

FIG. 6 illustrates an example of generating the score vector by the decoder 164 based on action set j from the encoder 162.

Let be matrices that convert hidden vectors into other hidden vectors. Let be an aggregation function that, for each action set takes hidden vectors as input and produces a single output hidden vector.

For generating a conditional probability vector, for each action set the following score vector is defined:
where is an activation function, and are elements from previous action sets.

### Integrating Preferences and Constraints Sets

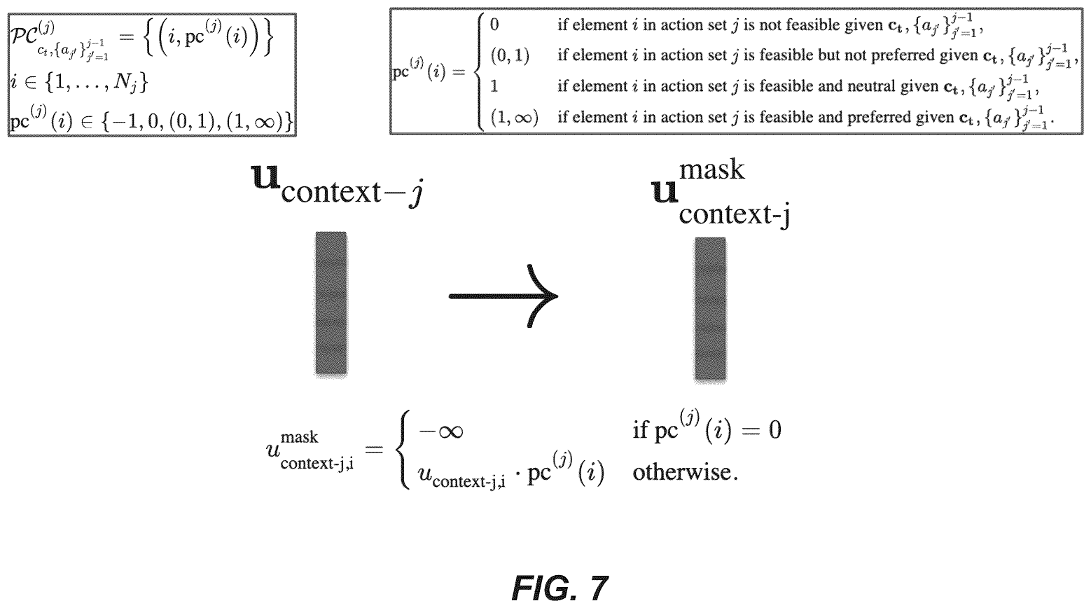

FIG. 7 illustrates an example of applying constraints and preferences into the score vector and creating the masked-score vector. Let denote the preference and constraint set for action set, conditioned on the context vector and previously selected elements from action sets earlier than action set. Define this set as follows:
where is a function of, and and it takes one of the following values:
defines the feasibility and preference of element based on the context and the previously selected elements.

To implement these preferences and constraints for each in the vector, define an updated vector where each element is modified based on the value of in the preference and constraint set:

Sampling from Conditional Distribution:

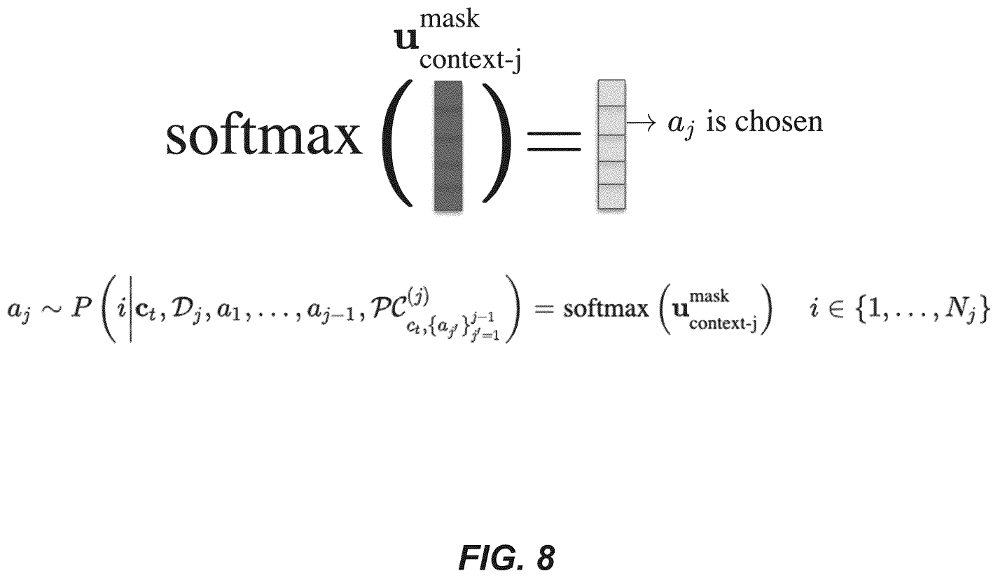

FIG. 8 illustrates an example of calculating the conditional probability vector from the masked-score vector and sampling an action element from the action set illustrated at FIG. 6. The conditional distribution is now calculated by taking the softmax over the masked scores. The computer system 110 samples from this distribution to select an action from action set

The hidden vector of the selected action in action set may be defined as:

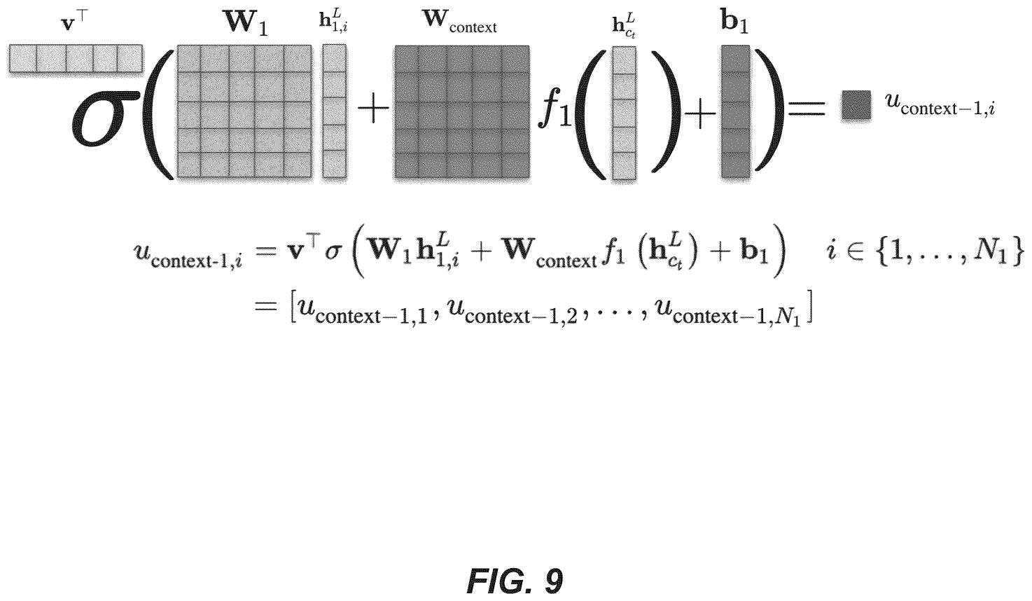

FIG. 9 illustrates an example of generating a score vector for a first action set.

The process of selecting a set of actions for context will now be described. First, the computer system 110 starts with action set. The computer system 110 may compute the vector where each element represents the strength of connection, or score, between the context and each element in actions set. These scores reflect the likelihood of selecting a specific element within the action set for the given context.

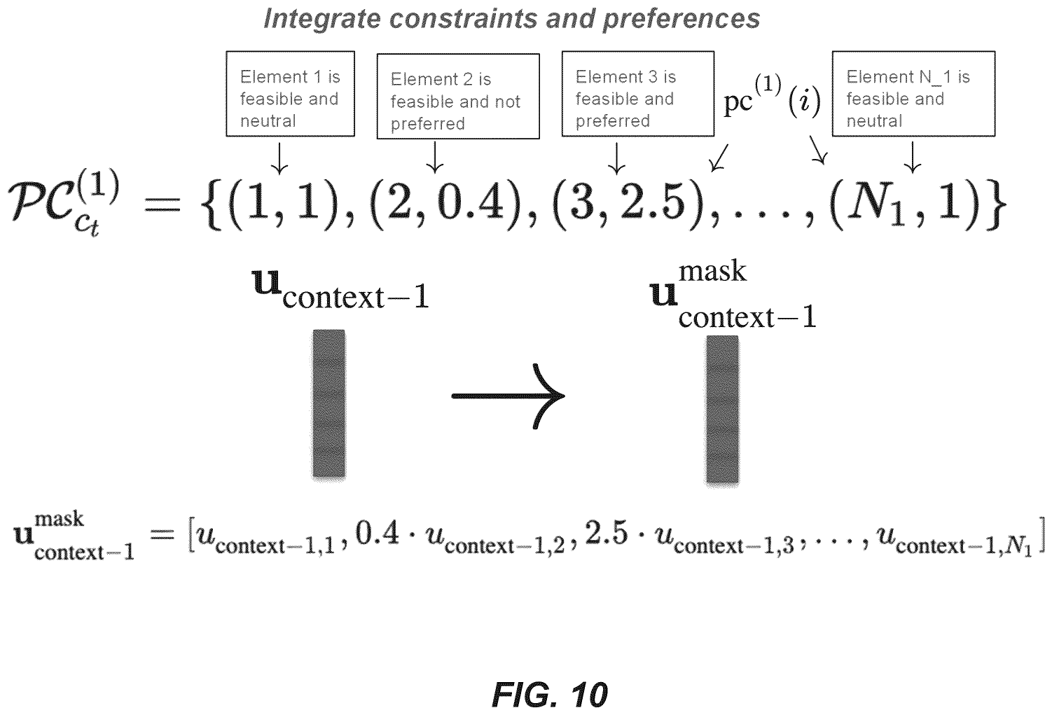

FIG. 10 illustrates an example of integrating constraints and preferences into the score vector for the first action set.

The computer system 110 may apply the preferences related to the context regarding elements in the first action set.
where

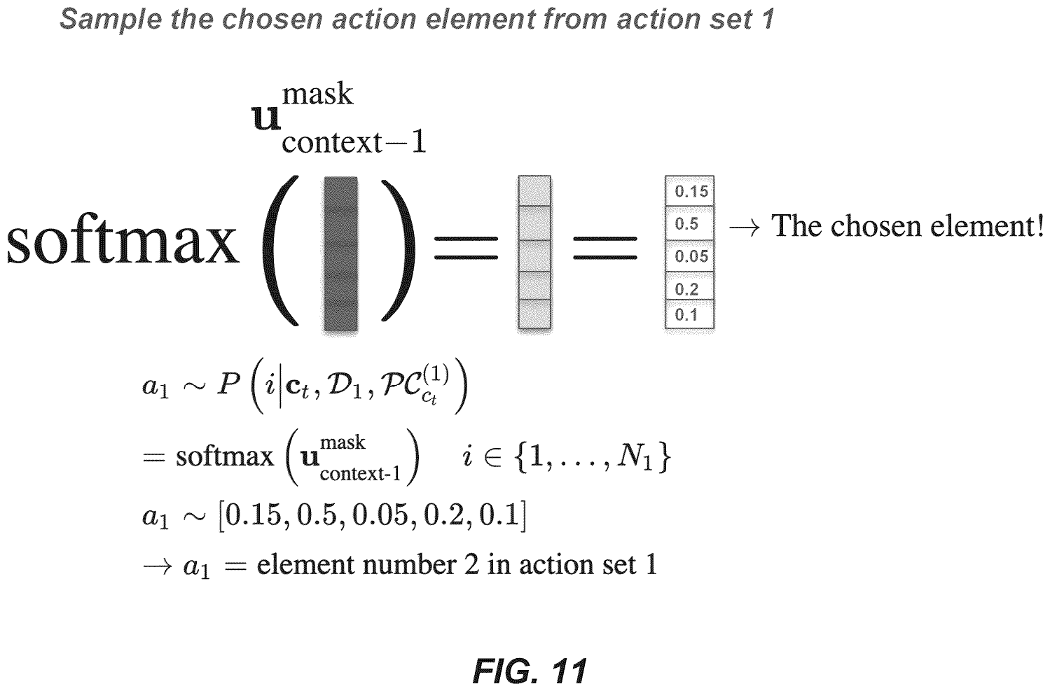

FIG. 11 illustrates an example of calculating the conditional probability vector from the masked-score vector over the first action set and sampling a chosen action element from the first action set.

Sampling from will result in the selected action from the first action set.

### Next, the Computer System 110 May Generate the Second Conditional Probability Vector:

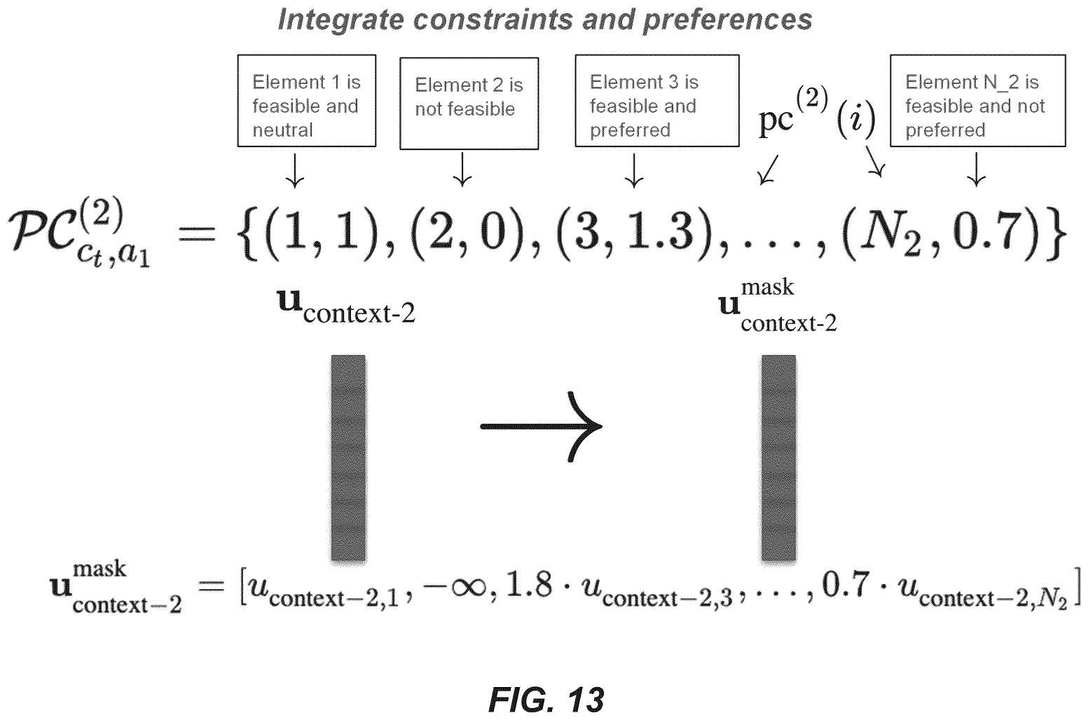

FIG. 13 illustrates an example of integrating constraints and preferences into the score vector for the second action set.

The preferences related to the context and the selected element from the first action set and regarding elements in the second action set, may be given by:
where

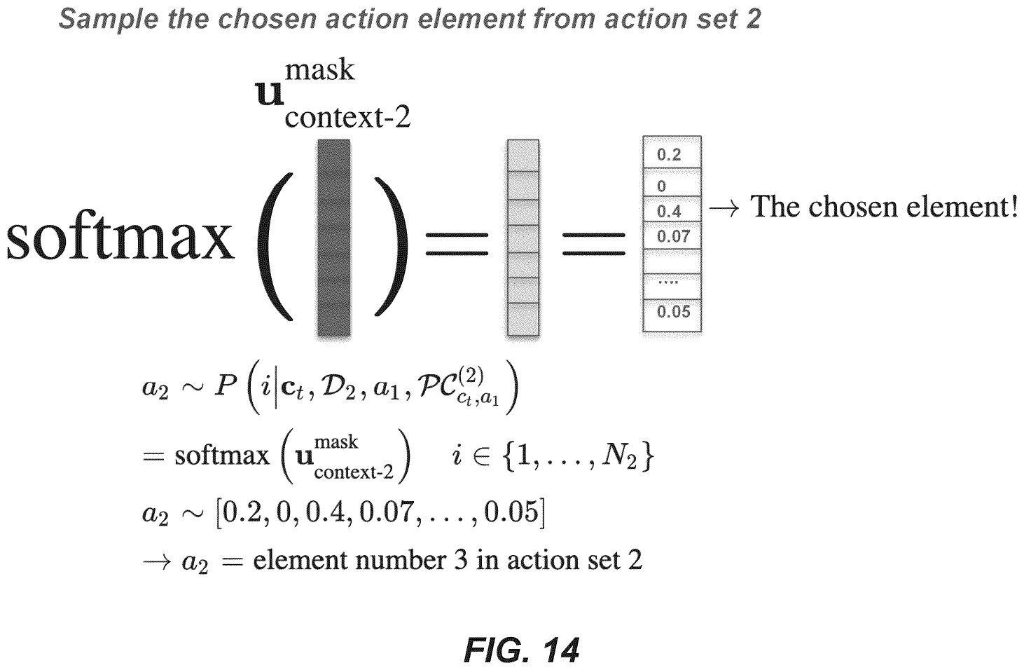

FIG. 14 illustrates an example of calculating the conditional probability vector from the masked-score vector over the second action set and sampling a chosen action element from the second action set.

Sampling from will result in the selected action from the second action set.

By continuing this process, the computer system 110 may sample the sub-actions in the action sequence.

### The Reinforcement Learning Formulation

Given the model architecture described above, the RL formulation may be precisely defined. Let be the set of all possible combinations of previously selected elements up to the action set. Then, The full preference and constraint set, considering all possible prior selected actions, is:

This represents the preferences and constraints for conditioned on the context of any possible previously selected subset of actions.

The state may be defined as:

The state may include the context at time, the previous and successive context (from other tasks) in a window of size around the current time, the action sets associated with that context, and the preference and constraint functions that account for all possible previously selected actions up to each. Note that this is a formal definition. In practice, due to our model architecture, we do not hold all the possible preferences and constraints. The computer system 110 may only have to know what are the relevant preferences and constraints, given the previously selected sub-actions. This reduces significantly the memory and time required to process the sub-actions selection.

Given this definition of the state, the computer system 110 may define how the final action sequence is sampled from a policy:

With the definitions of and for each time, the computer system 110 can now learn the policy that maximizes the objective function in Equation (2). To achieve this, various reinforcement learning approaches may be used such as on-policy, off-policy, and offline algorithms. Although a REINFORCE RL processing algorithm compatible with the model architecture is illustrated, other RL frameworks may be used.

### Reinforcement Learning Processing

1. Initialize the policy network with parameter
2. For each episode, sample:
   a. For from:

The disclosure may be used in various contexts. In various examples disclosed herein, scheduling patient appointments with care providers and clinics based on various constraints, preferences, and action sets are described. For example, the disclosure herein may provide technology solutions to aforementioned problems in neural networks with multi-objective optimizations with constraints and preferences. These technology solutions may be useful to address scheduling for fertility and other care provider appointments.

As the demand for fertility services increases, the importance of satellite services becomes more critical. A growing number of clinic hubs are being established, providing patients with access to multiple clinics and various care providers for medical services. Scheduling appointments in this complex environment is challenging, as numerous factors must be considered. Appointments like IVF or FET need to be scheduled on specific days within a woman's menstrual cycle. Additionally, there are constraints on the availability of care providers, and clinic facilities are shared between doctors and nurses. Therefore, a scheduling optimization model must also account for the availability of these facilities.

The disclosure may be used for scheduling optimization systems that schedules patients that need to attend specific appointment type to an available time-slot and to an available clinic facility and available care providers, while accounting the relevant entities constraints and maximizing the overall weighted interests of the entities in the computer system 110, such as the entities described below.

Fertility patients can include, but are not limited to, patients that would like to donate sperm/egg, preserve their eggs, go through a fertility treatment (for example IVF, FET, IUI), surrogate, among others. Possible interests that fertility patients might have when choosing with which fertility clinic and care providers they want to do their fertility treatment. One main consideration is the success rate of the care providers in the specific fertility treatment that the patient intends to go through. In most cases, patients would like to maximize the chance that their treatment will lead to a healthy live birth, hence they look for care providers with a proven record of high success in their intended treatment type. As a result, patients might choose clinic facilities that have advanced technology and high-quality lab equipment which might also increase the treatment success rate.

Sometimes, patients might prefer to choose their care providers not only according to the highest treatment success rate, but also to minimize the impact on daily life while maximizing the success rates of the treatment. Minimizing the impact on daily life can be, for example, starting the treatment as soon as possible, choosing a care provider that does the minimal duration of the treatment or that he achieved the most success in the fewest number of cycles. Patients might also choose a treatment that is least invasive which will also impact on which care providers they choose for this least invasive treatment. Patients might prefer to choose a clinic facility according to their location—the closest to their home, or near their work, or near additional necessary services such as pharmacy. In this case patients would like to choose a clinic facility that will save them day-to-day time and minimize transportation cost and effort, and looking for other services time and effort. Patients might also consider reviews from other patients regarding their experience with specific care providers and clinics. Positive reviews on the care provider professionally, personality, attitude to patient, level of sympathy might affect patient's choice. Regarding fertility clinics, patients might prefer clinics with positive reviews on the clinic's level of personal attention and level of service. That is, a patient might choose a care provider/clinic that does not necessarily have the highest success rate, but they are reported by other patients with high recommendations. Specifically interested in this case is the difference between a general recommendation found online for example, or a recommendation from some person that the patient is personally familiar with. In this case the recommendation might increase/decrease the willingness of the patient to follow this recommendation. Regarding recommendations—the same goes with recommendations from other doctors/family members/friends.

Constraints that are related to the patient are mostly related to the time slots. There are medical appointments that need to be done on specific days that are related to the patient's menstrual cycle. For example, an egg retrieval procedure should be on the 14-16 days after the first day of the menstrual cycle. This means that the time slots for this appointment are constrained by this limitation. Additional constraints might be related to a patient-clinic facility relation: For example, if a patient has some medical condition that requires him to visit only accessible clinic facilities, then we need to limit the possible offered clinic facilities to those that are accessible.

A patient might prefer to choose a care provider that meets some of the patient preferences. For example, a care provider that speaks the patient's mother tongue, or a specific care provider that was referred by the patient's doctor or recommended by a close friend. If the patient already met some care provider he might prefer to continue the treatment with this specific care provider, or the opposite—he might prefer to not proceed with this care provider and try a new one. A patient might have preferences also regarding the clinic facility—he might prefer a clinic facility that is close to other necessary medical services, or a clinic facility that has advanced technology. Other preferences might be related to the accessibility of the clinic facility and recommendations regarding this clinic facility. In addition, a patient can also have preferences regarding the time slot for the appointment. He might prefer specific hours in a day (only mornings/evenings) or specific days in the week. We emphasize that preferences are not treated as constraints. While constraints limit the possible options by prohibiting the options that do not meet the constraints, preferences can only increase/decrease the probability of some options, but it might be that eventually an appointment will be scheduled to a time slot or a care provider and facility that does not meet the patient's preferences. Appointments can include, but are not limited to, consultation, diagnostic testing (for example diagnostic imaging, HCG, saline sonogram), blood work appointment, semen analysis, Obstetric ultrasound, baseline encounter, follow-up encounter, cycle monitoring, procedure encounter (for example egg retrieval, IUI, embryo transfer, FET) among others.

Constraints: sufficient time-slots should be allocated to an appointment according to its duration. In addition, there might be appointments that need to be scheduled only before/after/in parallel to other appointments that have been scheduled for the same patient or to another patient. For example, a clinic might define that an egg retrieval appointment can only be scheduled after an initial consultation appointment and at least two monitoring appointments have been scheduled for the patient. Or a clinic might prefer to schedule a fresh Semen Analysis appointment for a male patient in parallel to an egg retrieval appointment for his female partner.

Care providers can include, but are not limited to, REI specialists, OBGYNs, embryologists, nurses, doctors, lab technicians, among others. Care providers would like to maximize their own success rate in specific treatments. In addition, in general they would like to maximize their income which can be achieved by maximizing the number of patients they receive or maximize the number of treatments they perform.

In addition, care providers might aim at maximizing their expertise in some type of medical condition. For example, a doctor that would like to be an expert in egg retrievals might want to maximize specifically the number of egg retrieval appointments he is scheduled for. Care providers might also want to maximize patient satisfaction since it will increase the number and quality of recommendations regarding these care providers.

Care providers have constraints regarding their schedule-They work in specific time slots (for example, weekdays, 09:00-18:00) and they are not working in other time slots (weekends for example). Care providers also have constraints regarding clinic facilities-They can work in a specific clinic facility that is adapted to the treatment that they provide. For example, REI can receive patients in a fertility clinic but cannot receive them in a lab. Normally, this constraint is related to both the appointment type and the clinic facility. In other cases a care provider can limit themselves to work only in clinic facilities that are in a specific geographical area. Care providers might prefer to work in clinic facilities that are close to their home/close to another clinic facilities they work in. They might also prefer specific time slots for appointments. For example, they might prefer to work in the evenings, even though they can also work in the mornings. In general, they might prefer adjacent booked time slots for the same care provider in the same clinic facility. Care providers can also prefer specific clinic facilities—with advanced technology, or with a professional staff that they trust. Care providers might prefer to NOT take specific appointment types. This can be the case when they want to increase their success rate and therefore they prefer to not take “hard cases”. Again, this is only a preference and not a constraint. If a specific care provider is the only one who can perform a specific treatment, he might be selected even though it does not meet his preferences.

Fertility clinics might have one or more of the following interests: maximizing the clinic's revenue, maximizing clinic efficiency—fewest appointments per treatment, maximizing the appointments that pay them the most, maximizing patient satisfaction (positive patient experience for example). This will result in an increase in the recommendations that the clinic receives, maximizing the number of patients, maximizing the clinic's success rate in several treatment types, and maximizing care provider's satisfaction.

Clinic facilities can include, but are not limited to, a doctor's office, a lab, an ultrasound scan room, an operation room, among others. Constraints that are related to a clinic facility are mostly affected by the schedule of the clinic facility. Once specific time slots are booked in some facility, it immediately blocks the options to schedule other appointments in these time slots. Other constraints are related to the relation of clinic facility and appointment and the relation of clinic facility and care provider. Some appointments can be held only in specific clinic facilities and some care providers can meet patients only in specific clinic facilities.

A clinic hub manages several clinic facilities, fertility clinics and several care providers. Then, when scheduling an appointment to a patient, the clinic hub can choose between all the options of available clinic facilities and care providers. In general, the clinic hub aims at maximizing its revenue along with maximizing patient satisfaction. This can be interpreted as maximizing the clinic hub's efficiency-receiving the maximum number of patients in the least amount of time and the lowest cost. Another interest might be to maximize the number of treatments.

An external entity can be, for example, an insurance company, a government or a state management, a religious entity, to name a few. A government might be interested in increasing or decreasing the country's population, which can be translated to increasing/decreasing the number of offered fertility treatments or increasing/decreasing the cost of these treatments. An insurance company might be interested in minimizing the fertility treatments costs and maximizing patients satisfaction.

Those having skill in the art will recognize that the computer system 110s and methods described herein may be used in other contexts in which multi-objective optimizations for combinatorial problems arise.

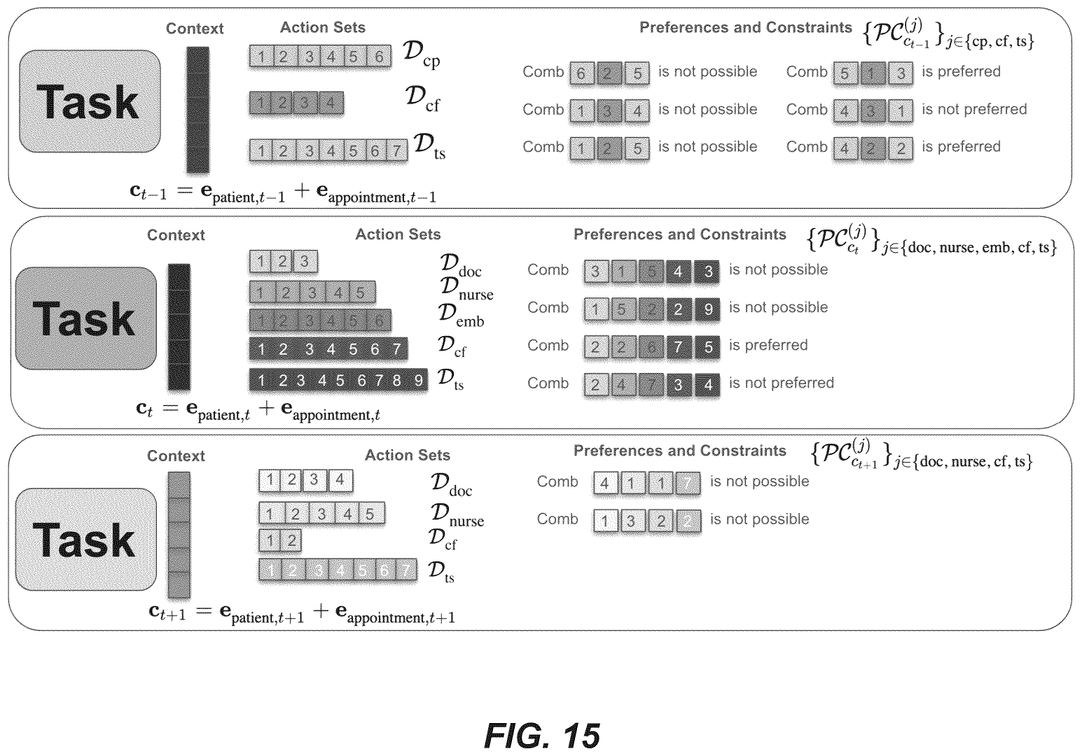

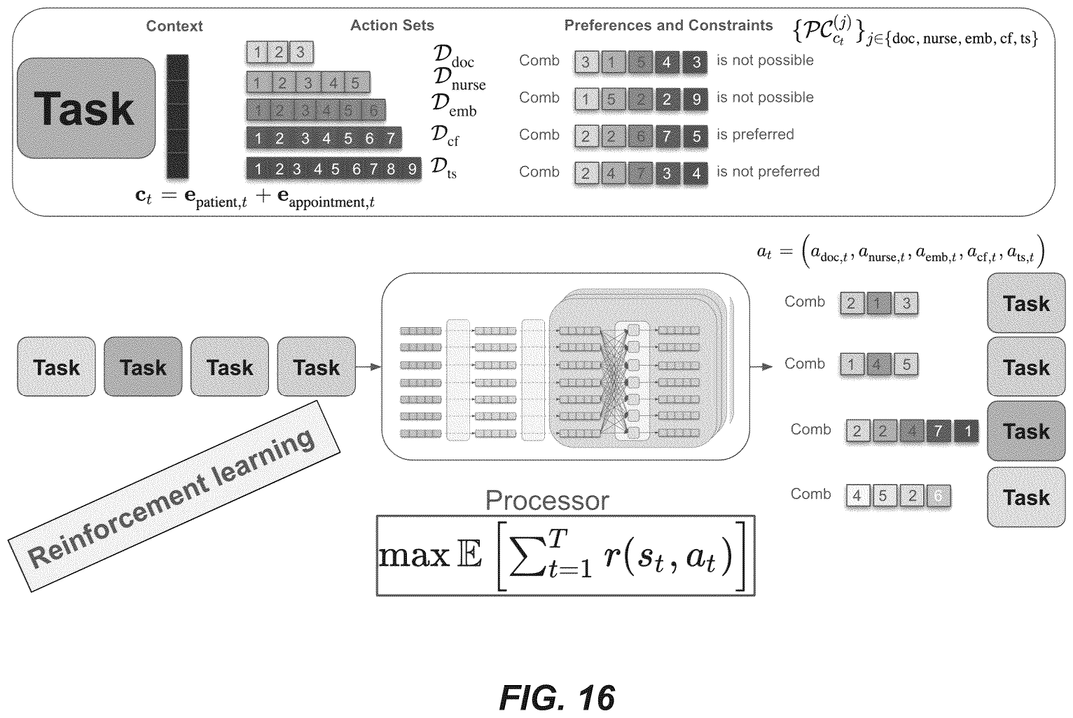

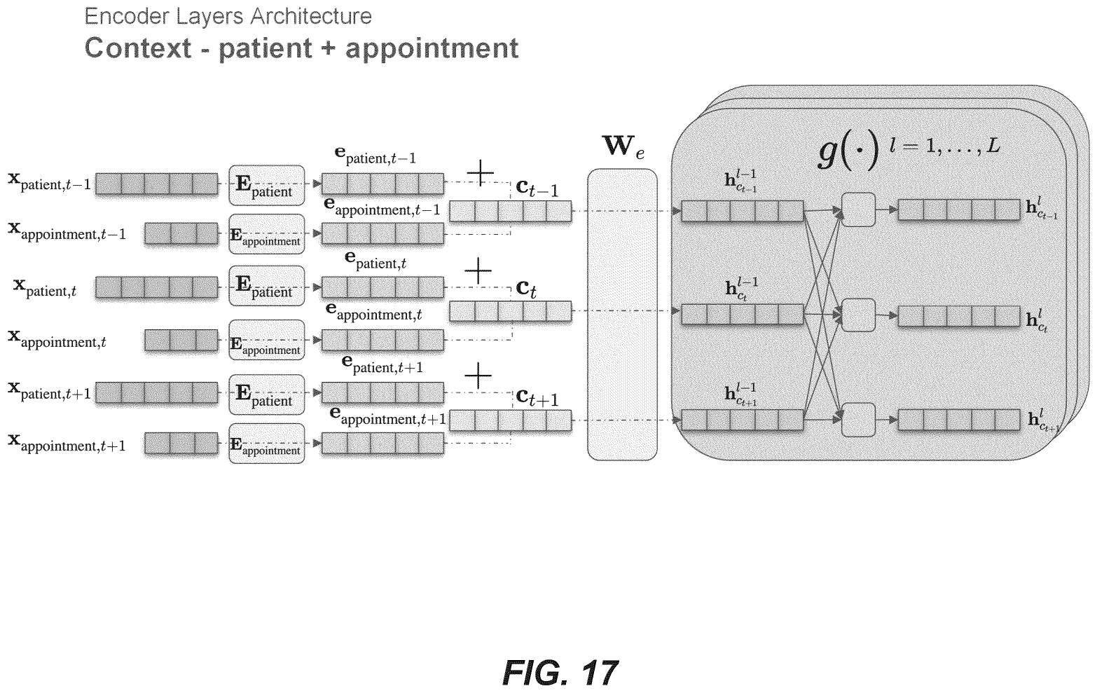

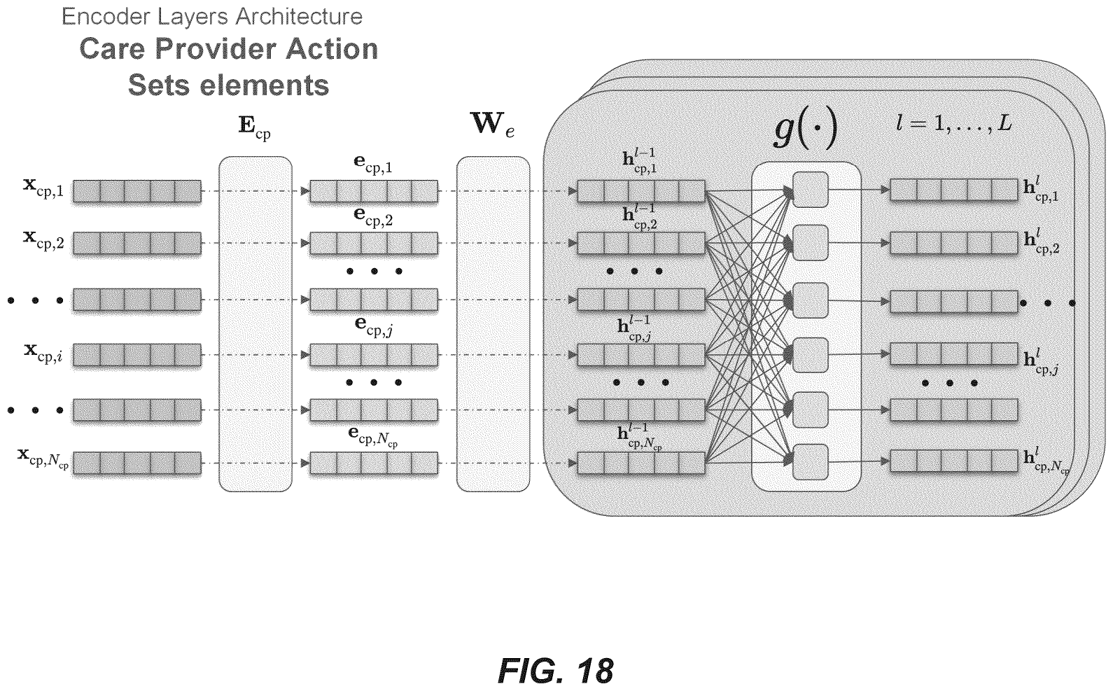

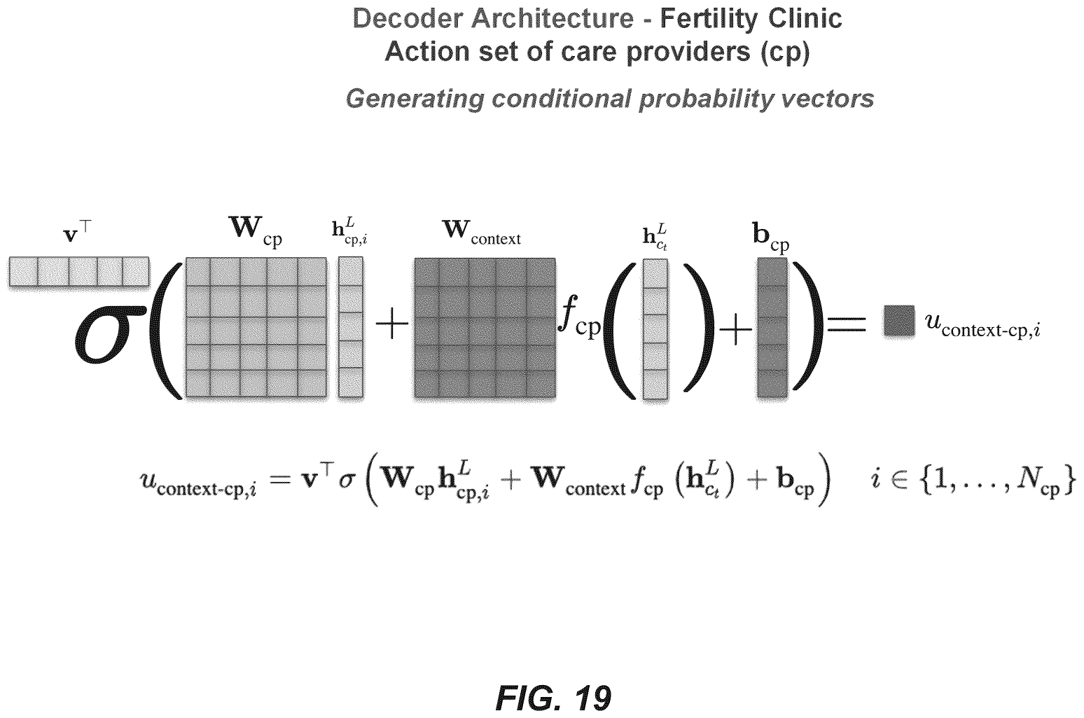

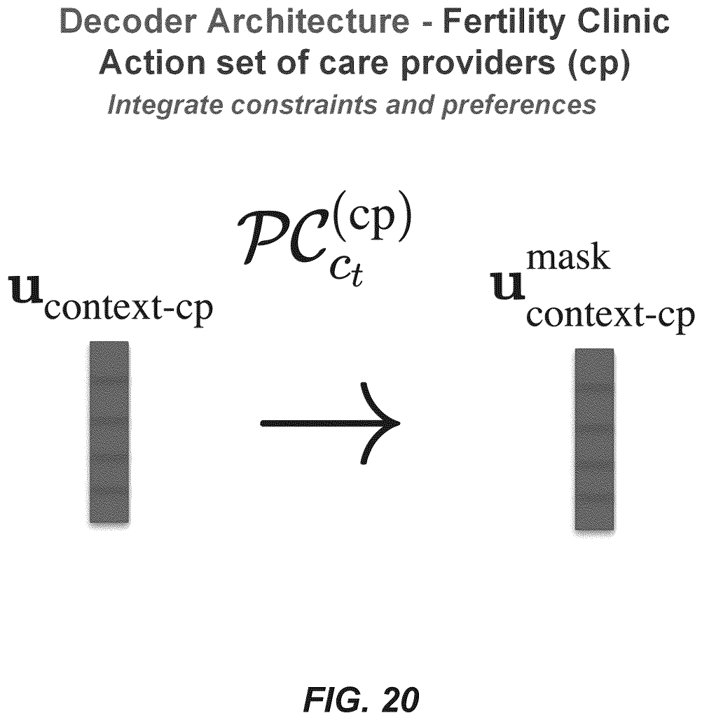

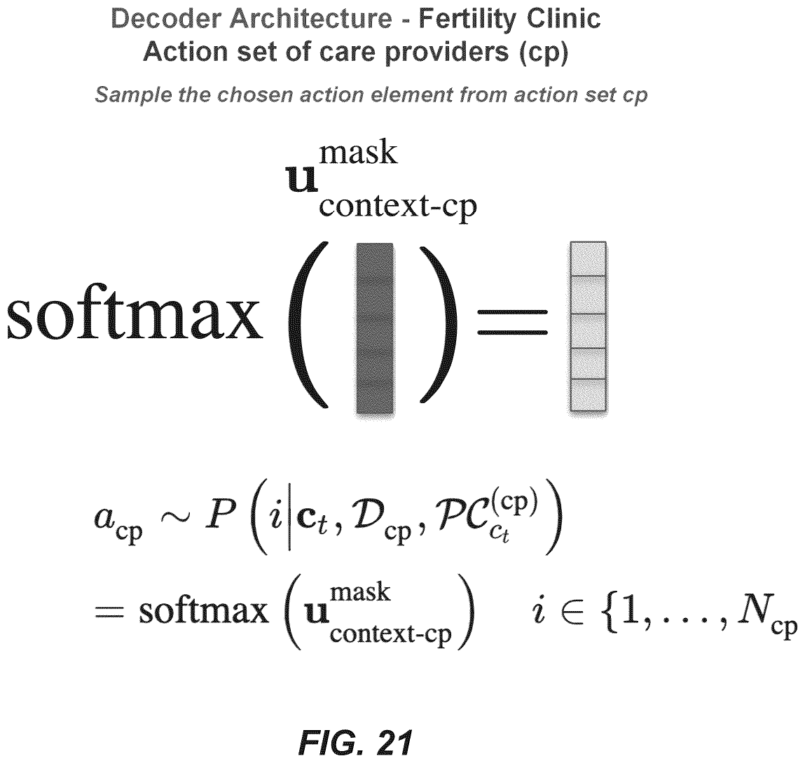

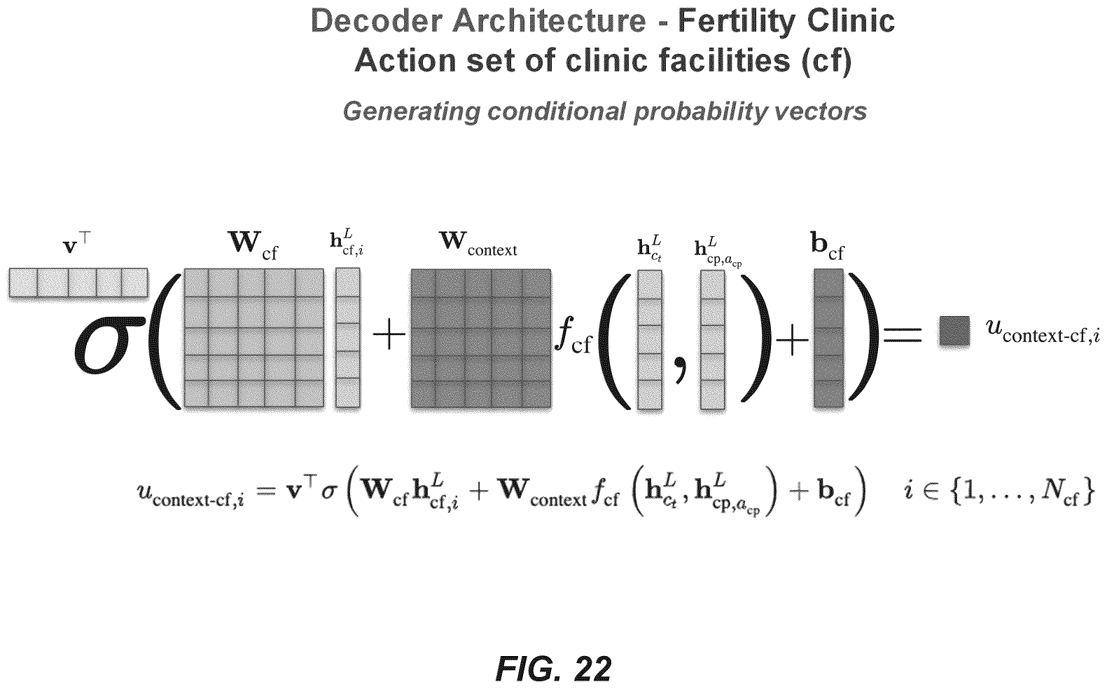

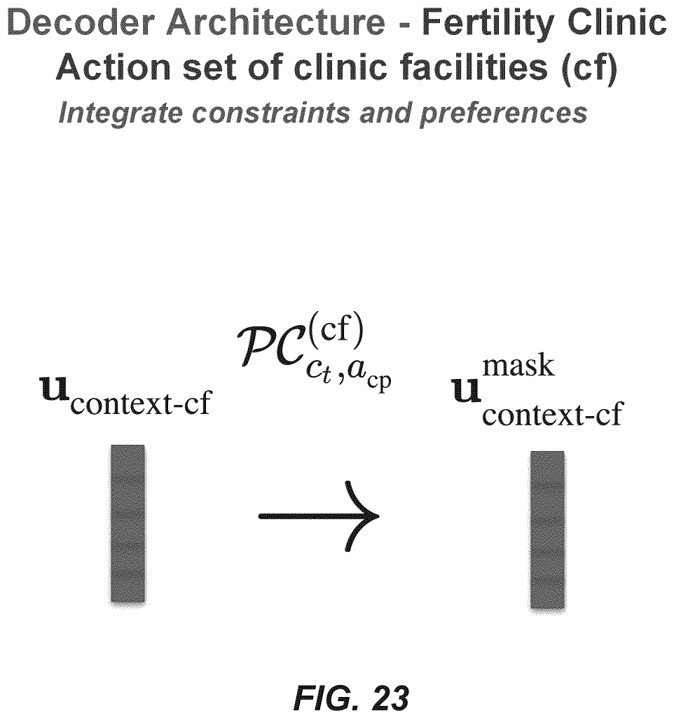

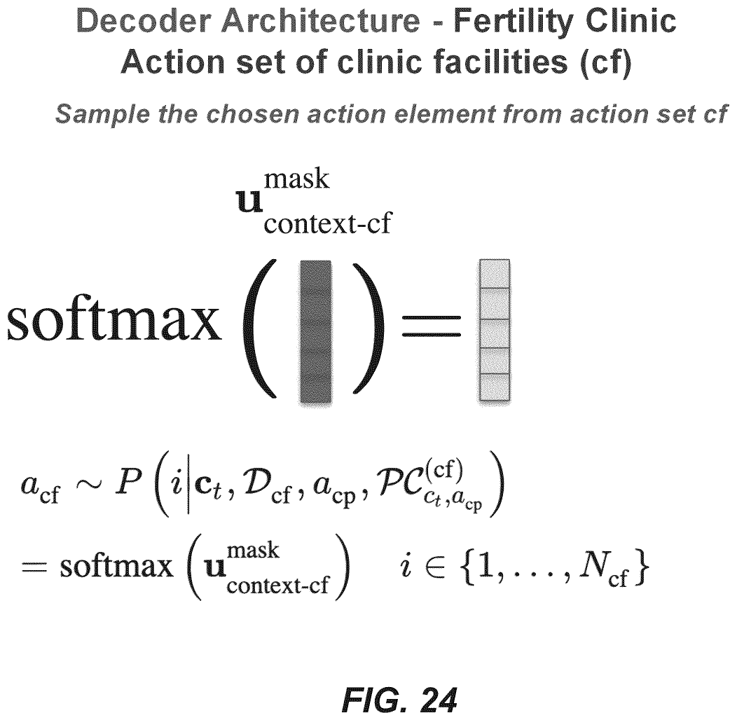

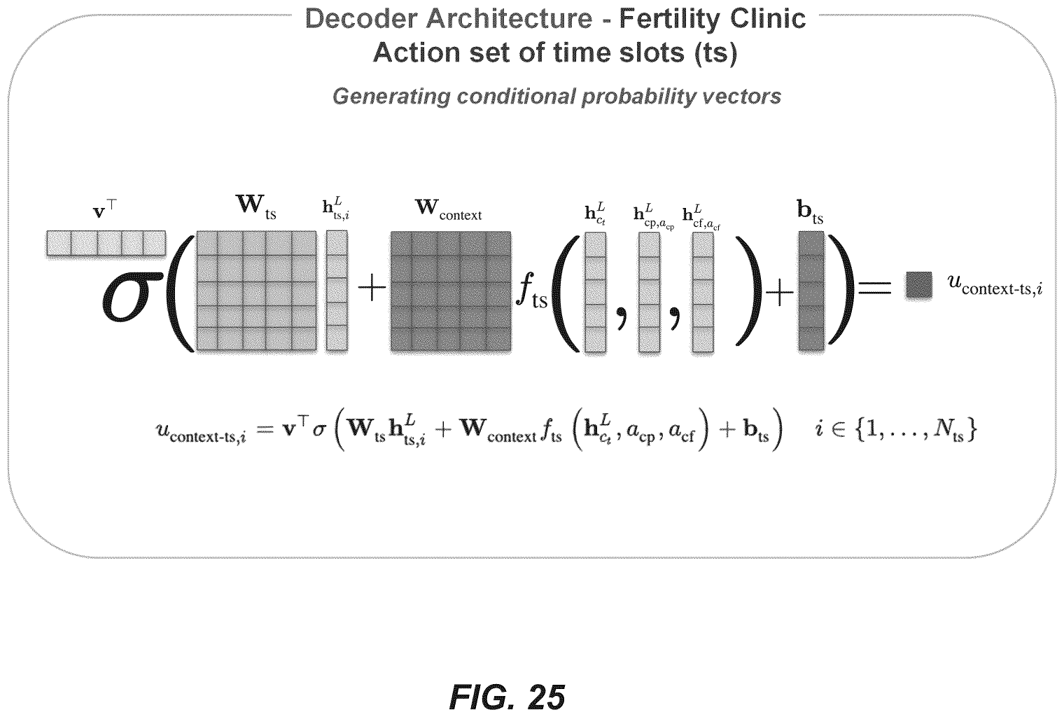

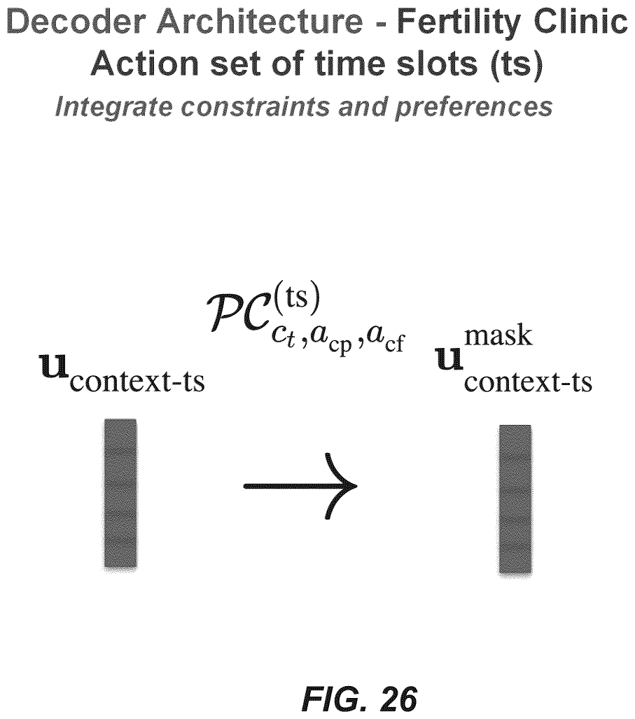

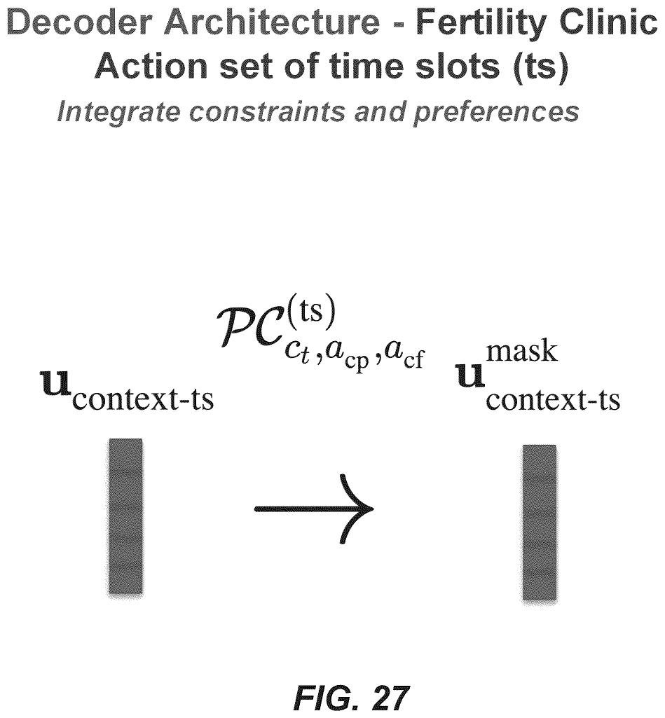

FIGS. 15-27 illustrate specific implementations of the computer system 110, encoder-decoder architecture and processing illustrated in FIGS. 1-8. The implementations illustrated in FIGS. 15-27 are in the context of scheduling patient appointments with care providers. In this context, a task may be to schedule a patient with a care provider. The context may include information about the appointment, patient, or other contextual data relating to the appointment. The action sets may include available times, dates, care provider locations at which the appointment is to occur, identity of one or more care providers for which the appointment is to be scheduled, and/or other action elements to be scheduled. The constraints may include unavailable times of one or more parties (patient and/or care providers) to be scheduled, unavailable dates, conflicts, unavailable locations, and/or other constraints that will prevent an action element from being selected. A constraint may eliminate an action element from selection. A preference may include a preference of a patient, care provider, clinical location, and/or other relevant entity that will be taken into consideration when selecting action elements but (unlike constraints) may not necessarily eliminate an action element.

In the specific implementations illustrated at FIG. 15-17, a given task may relate to scheduling an appointment based on contextual information 103, action sets 105, constraints 107, and preferences 109 illustrated in FIG. 1.

### Tencoding the Context—Example Implementation

In the domain of fertility clinics, the context will be combined from the patient information and the appointment information.

The computer system 110 may generate the feature vectors based on the context 103. In particular, computer system 110 may generate a first feature vector based on patient features and a second feature vector based on appointment features. The first feature vector will therefore be referred to as a “patient feature vector” and the second feature vector will be referred to as an “appointment feature vector.”

### Generating Patient and Appointment Embedding Vectors

The patient features from the context 103 may include latitude/longitude (such as for an address of the patient), current cycle type identifier, length of menstrual cycle (in days), relative current CD1 (first day of menstrual cycle), and gender. Other numbers and types of patient features may be used.

The appointment features may include appointment type, appointment duration, and appointment cost. The appointment types may include, for example, IVF monitoring, Consultation, FET monitoring, Lab Test, Egg Retrieval, Ultrasound, and/or others. Other numbers and types of appointment features may be used.

Let and be the feature vectors of patient and appointment processed at time, respectively, and indicate the size of the patient and appointment feature vectors, respectively.

The neural network 160 may learn embeddings based on observed features of patients and appointments. Thus, the embeddings will be referred to as “learnable embeddings.”

Let and be the patient and appointment embedding matrices, respectively. Then, the respective learnable embedding vectors are:

Encoding the Context from the Patient and Appointment Embedding Vectors

The computer system 110 may generate the context vector 161 (Ct) for the task 101 at time t based on the appointment embedding vector ( ) and the patient embedding vector ( )

Let be the context vector at time, calculated by:

Let be the hidden vector of the context:
where is a matrix that converts embedding vectors into hidden vectors.

The context hidden vectors are similar to the context hidden vectors described in FIG. 5.

### Encoding the Action Sets—Example Implementation

The computer system 110 may generate feature vectors based on the action set 105. In particular, computer system 110 may generate a first feature vector based on care provider features, the second feature vector based on clinic facility features, and the third feature vector based on time slot features. The first feature vector will therefore be referred to as a “care provider feature vector,” the second feature vector will be referred to as a “clinic facility feature vector,” and the third feature vector will be referred to as a “time slot feature vector.”

The care provider features from the action set 105 may include latitude/longitude (such as for an address of the care provider), gender of the care provider, and care provider cost. Other numbers and types of care provider features may be used. The computer system may generate the feature vector based on the care provider features. Thus, the feature vector will be referred to as the “care provider feature vector.”

The clinic facility features from the action set 105 may include latitude/longitude (such as for an address of the clinical facility). Other numbers and types of clinical facility features may be used. The computer system may generate the feature vector based on the clinic facility features. Thus, the feature vector will be referred to as the “clinic facility feature vector.”

The time slot from the action set 105 may include a day, an hour, and a time delta from the current time. Other numbers and types of time slot features may be used. The computer system may generate the feature vector based on the time slot features. Thus, the feature vector will be referred to as the “time slot feature vector.”

Let be the sets of care providers (cp), clinic facilities (cf) and time slots (ts):
where, and are the feature vectors of the care provider, clinic facility and time slot, respectively. Let, and be the care provider, clinic facility and time slot embedding matrices, respectively.

Then, the respective embedding vectors are:
Let, and be the hidden vectors of care provider, clinic facility and time slot, respectively:

Note that since there may be several care providers (such as doctors, nurses, embryologists), there may be specific hidden vector representation for each of these groups: for, for and for.

For each actions set, the hidden vectors of layer may be defined as:

### Decoder for Fertility Clinic Example

In the decoder we will combine information between the context and the elements of each set.

Let be matrices that convert hidden vectors into other hidden vectors.

First, the computer system 110 may compute the score vector with elements that contains the scores between the context and the different care providers:

The computer system 110 may apply the preferences related to the context regarding elements in action set.
where

Sampling from will give us the selected action (care provider in this example) from the first action set of care providers.

Next, the computer system 110 may generate the second score vector over clinic facilities:

The preferences related to the context and the selected care provider from the first action set of care providers and regarding elements in the action set of clinic facilities, is:
where

Sampling from will give us the selected action (clinic facility) from the action set of clinic facilities.

The computer system 110 may generate the last score vector over time slots:

The preferences related to the context, the selected care provider from the first action set of care providers and the selected clinic facility from the second action set of clinic facilities and regarding elements in the action set of time slots facilities, is:
where

Sampling from will give us the selected action (time slot) from the action set of time slots.

The selected action combination for context may be.

### Rewards

In some examples, rewards may be used when implementing computer system 110 in the scheduling patient appointments example. The rewards will be used in solving the optimization problem in equation (2).

Rewards that Benefit the Clinic Hub

A clinic hub would like to maximize its total revenue from treatments. Usually, a treatment revenue is calculated by subtracting the hub's cost for care providers service and for clinic facility rent from the payment the hub receives from the patient. However, the computer system 110 may not want to give as input to the model the patient's treatment cost, since it may depend on other criteria that might not be known in advance. Hence, instead of maximizing the hub's revenue from treatments, the computer system 110 may minimize the hub's cost of resources (care provider and care facility) per treatment. The computer system 110 may multiply the number of time slots required for the appointment by the sum of selected cs and care facility cost per time slot. In addition, the computer system 110 may also minimize the transportation cost of the selected care provider to the selected care facility. Note that the transportation cost should only be included if the selected time slot is at the beginning/end of day.

$${r}_{treat {co}_{-} st} ( s , a ) = - \# ts ( s ) \cdot ( {cost}_{c p} ( a ) + {cost}_{cf} ( a ) ) - d i s {t}_{c p - c f} ( a ) \cdot {cost}_{dist}$$

Sometimes, a clinic hub is interested in maximizing its total number of appointments:

$${r}_{app} ( s , a ) = \{ \begin{matrix}1 & if a is a valid action ( allowed cp , cf and ts ) for the patient in s \\ 0 & otherwise\end{matrix}$$

If a clinic hub is interested in maximizing the number of treatments (vs number of appointments), the computer system 110 may collect in the patient feature information whether this appointment is part of a series of appointments that create a “treatment” (for example IVF treatment may result 7 appointments) and what is the position of this specific appointment in the series of appointment. For example, the current appointment is third out of 7.

$${r}_{treat} ( s , a ) = \{ \begin{matrix}1 & if a is a valid action and this app is the first for a treatment ( info in s ) \\ 0 & otherwise\end{matrix}$$

If the clinic is interested in maximizing the number of different patients served in the hub, we can collect data that indicates if it is the first appointment scheduled for a patient, and reward new patients.

$${r}_{patient\_count} ( s , a ) = \{ \begin{matrix}1 & if a is a valid action and this patient is new ( info in s ) \\ 0 & otherwise\end{matrix}$$

Rewards that Benefit the Patient

The hub might be interested to schedule appointments that will satisfy the patient. For example, scheduling in a clinic that is close to the patient's current location, or selecting a care provider and/or time slot and/or clinic facility that is aligned to the patient preferences.

$${r}_{dist - patient - cf} ( s , a ) = - {dist}_{patient - cf} ( s , a )$$

$${r}_{patient\_preference} ( s , a ) = \{ \begin{matrix}1 & if a meets patient preferences ( info in preferences masking ) \\ 0 & otherwise\end{matrix}$$

Rewards that Benefit the Care Provider

The hub may be interested to schedule appointments that will satisfy the care provider. For example, scheduling in a clinic that is close to the care provider current location, or selecting a time slot or care facility that is aligned to the care provider preferences.

$${r}_{dist cp - cf} ( s , a ) = - {dist}_{cp - cf} ( a )$$

$${r}_{cp\_preference} ( s , a ) = \{ \begin{matrix}1 & if a meets care provider preferences ( info in preferences masking ) \\ 0 & otherwise\end{matrix}$$

### Total Reward

Let r_{type_i} be the reward of typeᵢ, where typeᵢ ∈D_{types}={treat cost, app, treat, patient count, dist patient-cf, patient preference, cp preference, . . . }.

The overall reward in each time step t is defined as

$$r ( {s}_{t} , {a}_{t} ) = {\sum }_{i = 1}^{\vert {D}_{t y p e s} \vert} {α}_{{type}_{i}} \cdot {r}_{{type}_{i}}$$

and the weights {α_{type}_{ᵢ}}=ᵢ₌₁^{|D}^{_{types|}} are determined by the clinic based on what they aim to maximize and the extent to which they prioritize it. This reward is used in the maximization problem in equation (2).

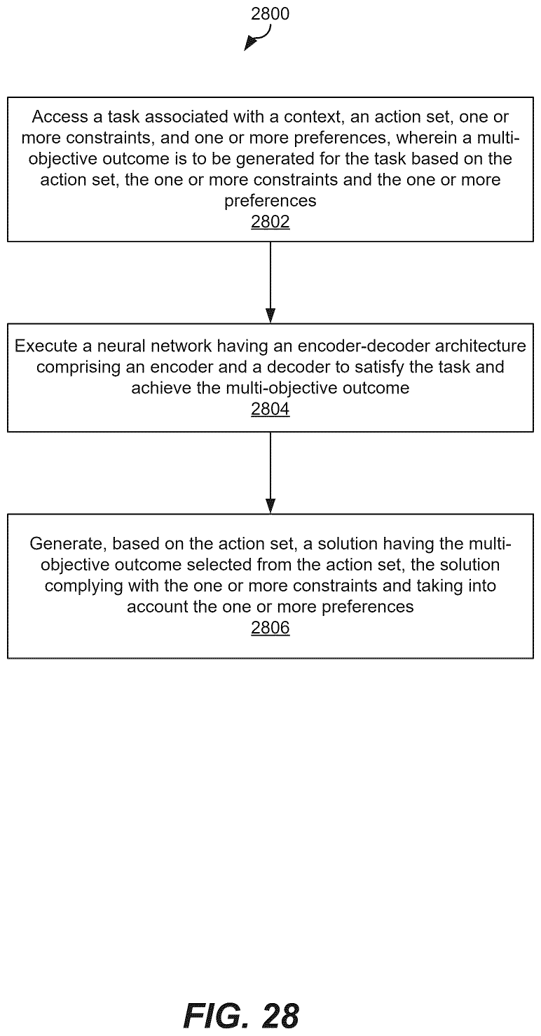

FIG. 28 illustrates a method 2800 of generating a solution having multi-objective optimization based on an action set, constraints, context and preferences using a neural network having an encoder-decoder architecture.

At 2802, the method 2800 may include accessing a task associated with a context, an action set, one or more constraints, and one or more preferences, wherein a multi-objective outcome is to be generated for the task based on the action set, the one or more constraints and the one or more preferences.

At 2804, the method 2800 may include executing a neural network having an encoder-decoder architecture comprising an encoder and a decoder to satisfy the task and achieve the multi-objective outcome, wherein the neural network applies one or more preferences in a mask-like function that to take into account the one or more preferences.

At 2806, the method 2800 may include generating, based on the action set, a solution having the multi-objective outcome selected from the action set, the solution complying with the one or more constraints and taking into account the one or more preferences.

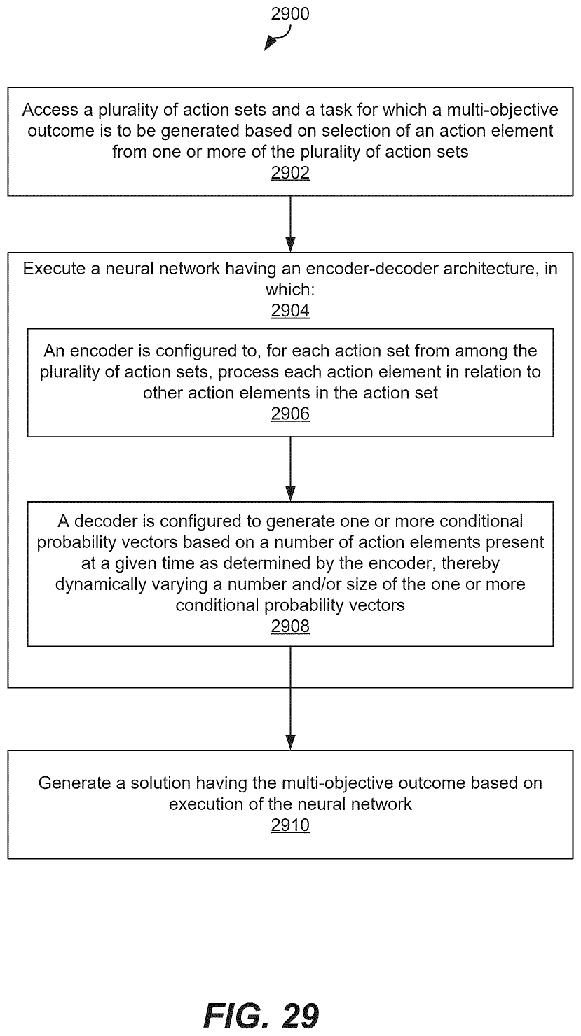

FIG. 29 illustrates a method 2900 of generating a solution having multi-objective optimization using a neural network having an encoder-decoder architecture. At 2902, the method may include accessing a plurality of action sets and a task for which a multi-objective outcome is to be generated based on selection of an action element from one or more of the plurality of action sets. At 2904-2908, the method 2900 may include executing a neural network having an encoder-decoder architecture in which: for each action set from among the plurality of action sets: processing, by an encoder, each action element in relation to other action elements in the action set; and generating, by a decoder, one or more conditional probability vectors based on a number of action elements present at a given time as determined by the encoder, thereby dynamically varying a number and/or size of the one or more conditional probability vectors. At 2902, the method 2900 may include generating a solution having the multi-objective outcome based on execution of the neural network.

### Examples of Systems and Computing Devices

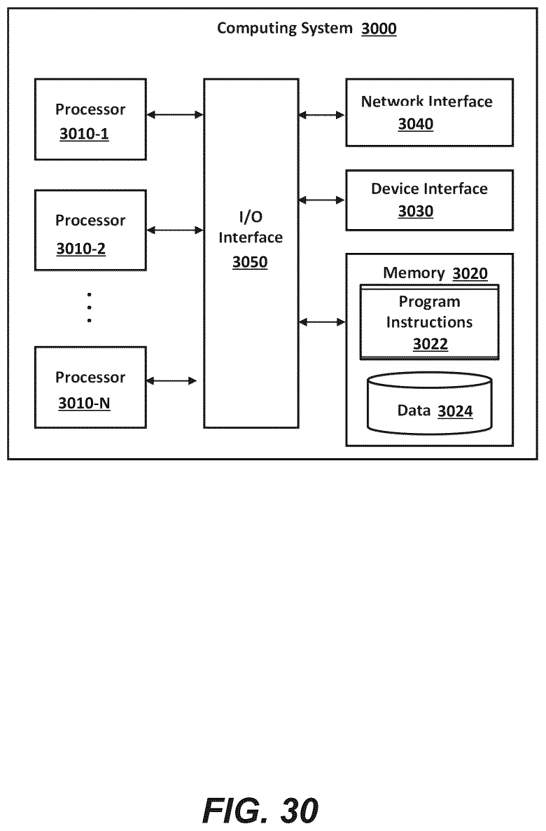

FIG. 30 illustrates an example of a computing system 3000 implemented by one or more of the devices illustrated in FIG. 1. Various portions of systems and methods described herein, may include or be executed on one or more computer systems similar to computing system 3000. Further, processes and modules described herein may be executed by one or more processing systems similar to that of computing system 3000. In some embodiments, computing device 120 or other components of system environment may include some or all of the components and features of computing system 3200.

Computing system 3000 may include one or more processors (for example, processors 3010-1 3010-N) coupled to system memory 3020, an input/output I/O device interface 3030, and a network interface 3040 via an input/output (I/O) interface 3050. A processor may include a single processor or a plurality of processors (for example, distributed processors). A processor may be any suitable processor capable of executing or otherwise performing instructions. A processor may include a central processing unit (CPU) that carries out program instructions to perform the arithmetical, logical, and input/output operations of computing system 3000. A processor may execute code (for example, processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (for example, system memory 3020). Computing system 3000 may be a uni-processor system including one processor (for example, processor 3010-1), or a multi-processor system including any number of suitable processors (for example, 3010-1-3010-N). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, for example, an FPGA (field programmable gate array) or an ASIC (application specific integrated circuit). Computing system 3000 may include a plurality of computing devices (for example, distributed computer systems) to implement various processing functions.

I/O device interface 3030 may provide an interface for connection of one or more I/O devices to computing system 3000. I/O devices may include devices that receive input (for example, from a user) or output information (for example, to a user). I/O devices may include, for example, graphical user interface presented on displays (for example, a cathode ray tube (CRT) or liquid crystal display (LCD) monitor), pointing devices (for example, a computer mouse or trackball), keyboards, keypads, touchpads, scanning devices, voice recognition devices, gesture recognition devices, printers, audio speakers, microphones, cameras, or the like. I/O devices may be connected to computing system 3000 through a wired or wireless connection. I/O devices may be connected to computing system 3000 from a remote location. I/O devices located on remote computer system, for example, may be connected to computing system 3000 via network interface 3040.

Network interface 3040 may include a network adapter that provides for connection of computing system 3000 to a network. Network interface 3040 may facilitate data exchange between computing system 3000 and other devices connected to the network. Network interface 3040 may support wired or wireless communication. The network may include an electronic communication network, such as the Internet, a local area network (LAN), a wide area network (WAN), a cellular communications network, or the like.

System memory 3020 may store program instructions 3022 or data 3024. Program instructions 3022 may be executable by a processor (for example, one or more of processors 3010-1-3010-N) to implement one or more embodiments of the present techniques. Program instructions 3022 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (for example, one or more scripts stored in a markup language document), in a single file dedicated to the program in question, or in multiple coordinated files (for example, files that store one or more modules, sub programs, or portions of code). A computer program may be deployed to be executed on one or more computer processors located locally at one site or distributed across multiple remote sites and interconnected by a communication network.

System memory 3020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (for example, flash memory, ROM, PROM, EPROM, EEPROM memory), volatile memory (for example, random access memory (RAM), static random access memory (SRAM), synchronous dynamic RAM (SDRAM)), bulk storage memory (for example, CD-ROM and/or DVD-ROM, hard-drives), or the like. System memory 3020 may include a non-transitory computer readable storage medium that may have program instructions stored thereon that are executable by a computer processor (for example, one or more of processors 3010-1 3010-N) to cause the subject matter and the functional operations described herein. A memory (for example, system memory 3020) may include a single memory device and/or a plurality of memory devices (for example, distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 3050 may coordinate I/O traffic between processors 3010-1 3010-N, system memory 3020, network interface 3040, I/O devices, and/or other peripheral devices. I/O interface 5300 may perform protocol, timing, or other data transformations to convert data signals from one component (for example, system memory 3020) into a format suitable for use by another component (for example, processor 3010-1, processor 3010-2, . . . , processor 3010-N). I/O interface 5300 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 3000 or multiple computing systems 3000 configured to host different portions or instances of embodiments. Multiple computing systems 3000 may provide for parallel or sequential processing/execution of one or more portions of the techniques described herein.

Those skilled in the art will appreciate that computing system 3000 is merely illustrative and is not intended to limit the scope of the techniques described herein. Computing system 3000 may include any combination of devices or software that may perform or otherwise provide for the performance of the techniques described herein. For example, computing system 3000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 3000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the computer system 110 components or data structures may also be stored (for example, as instructions or structured data) on a computer-accessible medium or a portable article to be read by an appropriate drive, various examples of which are described above. In some embodiments, instructions stored on a computer-accessible medium separate from computing system 3200 may be transmitted to computing system 3200 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (for example, content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (in other words, meaning having the potential to), rather than the mandatory sense (in other words, meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, in other words, encompassing both “and” and “or.” Terms describing conditional relationships, for example, “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, for example, “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, for example, the antecedent is relevant to the likelihood of the consequent occurring. Statements in which a plurality of attributes or functions are mapped to a plurality of objects (for example, one or more processors performing steps A, B, C, and D) encompasses both all such attributes or functions being mapped to all such objects and subsets of the attributes or functions being mapped to subsets of the attributes or functions (for example, both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, in other words, each does not necessarily mean each and every. Limitations as to sequence of recited steps should not be read into the claims unless explicitly specified, for example, with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (for example, “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, for example, reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, for example, text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, for example, in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (for example, articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a processor programmed to:
access a plurality of action sets and a task for which a multi-objective outcome is to be generated based on selection of an action element from one or more of the plurality of action sets;
execute a neural network having an encoder-decoder architecture in which:
an encoder is configured to, for each action set from among the plurality of action sets, process each action element in relation to other action elements in the action set;
a decoder is configured to generate one or more conditional probability vectors based on a number of action elements present at a given time as determined by the encoder, thereby dynamically varying a number and/or size of the one or more conditional probability vectors; and
generate a solution having the multi-objective outcome based on execution of the neural network.

2. The system of claim 1, wherein the processor is further programmed to:
access contextual information across a plurality of time steps;
wherein the encoder generates a plurality of hidden context vectors based on the contextual information, each hidden context vector corresponding to a respective time step; and
wherein the generated solution is based further on the plurality of hidden context vectors.

3. The system of claim 2, wherein to generate the plurality of hidden context vectors, the processor is further programmed to:
generate, for the contextual information at a time step, a corresponding embedding context vector for the time step; and
convert the embedding context vector into a hidden context vector.

4. The system of claim 3, wherein to generate the plurality of hidden context vectors, the processor is further programmed to:
apply an aggregation function to the plurality of hidden context vectors;
generate a plurality of new hidden context vectors based on the aggregation function, wherein each new hidden context vector includes information learned from other ones of the new hidden context vectors such that each new hidden context vector will hold information of other contexts.

5. The system of claim 4, wherein the aggregation function uses a Graph Neural Network architecture or a Transformer architecture.

6. The system of claim 2, wherein to process each action set, the encoder is configured to:
process each action set with associated contextual information at each time step so that each action set is analyzed in context at each time step.

7. The system of claim 6, wherein the encoder is configured to:
generate an action set feature vector for each action set at each time step, wherein the feature dimension is based on a number of action elements in the action set;
generate an embedding matrix for each action set based on the corresponding action set feature vector; and
generate a plurality of hidden action set vectors based on the embedding matrices of the action sets.

8. The system of claim 7, wherein the encoder is configured to:
generate a plurality of new hidden action set vectors based on an aggregation function, wherein each new hidden action set vector includes information learned from other ones of the new hidden context vectors and between encoder layers such that each new hidden action set vector will hold information of other hidden action set vectors among and across the encoder layers.

9. The system of claim 8, wherein the aggregation function uses a Graph Neural Network architecture or a Transformer architecture.

10. The system of claim 1, wherein the neural network applies one or more preferences in a mask-like function that takes into account the one or more preferences.

11. A method, comprising:
accessing, by a processor, a plurality of action sets and a task for which a multi-objective outcome is to be generated based on selection of an action element from one or more of the plurality of action sets;
executing, by the processor, a neural network having an encoder-decoder architecture in which:
for each action set from among the plurality of action sets, processing, by an encoder, each action element in relation to other action elements in the action set;
generating, by a decoder, one or more conditional probability vectors based on a number of action elements present at a given time as determined by the encoder, thereby dynamically varying a number and/or size of the one or more conditional probability vectors; and
generating, by the processor, a solution having the multi-objective outcome based on execution of the neural network.

12. The method of claim 11, further comprising:
accessing contextual information across a plurality of time steps;
wherein the encoder generates a plurality of hidden context vectors based on the contextual information, each hidden context vector corresponding to a respective time step; and
wherein the generated solution is based further on the plurality of hidden context vectors.

13. The method of claim 12, wherein generating the plurality of hidden context vectors, comprises:
generating, for the contextual information at a time step, a corresponding embedding context vector for the time step; and
converting the embedding context vector into a hidden context vector.

14. The method of claim 13, wherein generating the plurality of hidden context vectors, comprises:
applying an aggregation function to the plurality of hidden context vectors;
generating a plurality of new hidden context vectors based on the aggregation function, wherein each new hidden context vector includes information learned from other ones of the new hidden context vectors such that each new hidden context vector will hold information of other contexts.

15. The method of claim 14, wherein the aggregation function uses a Graph Neural Network architecture or a Transformer architecture.

16. The method of claim 12, wherein processing each action set comprises:
processing each action set with associated contextual information at each time step so that each action set is analyzed in context at each time step.

17. The method of claim 16, further comprising:
generating an action set feature vector for each action set at each time step, wherein the feature dimension is based on a number of action elements in the action set;
generating an embedding matrix for each action set based on the corresponding action set feature vector; and
generating a plurality of hidden action set vectors based on the embedding matrices of the action sets.

18. The method of claim 17, further comprising:
generating a plurality of new hidden action set vectors based on an aggregation function, wherein each new hidden action set vector includes information learned from other ones of the new hidden context vectors and between encoder layers such that each new hidden action set vector will hold information of other hidden action set vectors among and across the encoder layers.

19. The method of claim 11, further comprising:
applying one or more preferences in a mask-like function that takes into account the one or more preferences.

20. A system, comprising:
a processor programmed to:
access a task associated with a context, an action set, one or more constraints, and one or more preferences, wherein a multi-objective outcome is to be generated for the task based on the action set, the one or more constraints and the one or more preferences;
execute a neural network having an encoder-decoder architecture comprising an encoder and a decoder to satisfy the task and achieve the multi-objective outcome, wherein the neural network applies one or more preferences in a mask-like function that to take into account the one or more preferences; and
generate, based on the action set, a solution having the multi-objective outcome selected from the action set, the solution complying with the one or more constraints and taking into account the one or more preferences.
